(19) United States
(12) Patent Application Publication
(10) Pub. No.: US 2022/0189714 A1
(43) Pub. Date: Jun. 16, 2022

(54) KEYSWITCH SUPPORT CONNECTION STRUCTURE AND KEYSWITCH STRUCTURE THEREWITH

(71) Applicant: DARFON ELECTRONICS CORP., Taoyuan City (TW)

(72) Inventors: Po-Chun Hou, Taoyuan City (TW); Chin-Hung Lin, Taoyuan City (TW)

(73) Assignee: DARFON ELECTRONICS CORP., Taoyuan City (TW)

(21) Appl. No.: 17/684,441

(22) Filed: Mar. 2, 2022

Related U.S. Application Data
(63) Continuation-in-part of application No. 17/216,707, filed on Mar. 30, 2021.
(60) Provisional application No. 63/002,378, filed on Mar. 31, 2020.
(60) Provisional application No. 63/005,473, filed on Apr. 6, 2020.
(60) Provisional application No. 63/046,705, filed on Jul. 1, 2020.
(60) Provisional application No. 63/061,143, filed on Aug. 4, 2020.

(30) Foreign Application Priority Data
Nov. 5, 2020 (TW) 109138587
Mar. 10, 2021 (TW) 110108410
Mar. 10, 2021 (TW) 110108416

(51) Int. Cl. H01H 13/14; H01H 13/10; H01H 3/12; H01H 13/04

(52) U.S. Cl. CPC H01H 13/14; H01H 13/10; H01H 2233/07; H01H 13/04; H01H 3/125

(57) ABSTRACT

A keyswitch support connection structure is a combined structure which includes a structural plate and a joining portion. The joining portion and the structural plate are firmly engaged with each other through a joining structure of the structural plate. The joining structure includes at least one of a protruding portion, a through hole, a side hole, a joining hole, a cantilever plate, and a protruding bridge portion. The joining portion includes at least one hook arm, configured to forma support connection portion. A keyswitch structure includes a base, a keycap above the base, two keyswitch supports connected to and between the base and the keycap, and the keyswitch support connection structure structurally integrated into the base or the keycap. The keycap is vertically movable relative to the base through the two keyswitch supports. One of the two keyswitch supports is connected to the support connection portion.

### CROSS REFERENCE TO RELATED APPLICATIONS

This application is a continuation-in-part application of application Ser. No. 17/216,707, filed Mar. 30, 2021, which claims the benefit of U.S. Provisional Application No. 63/002,378 filed on Mar. 31, 2020, Application No. 63/005,473 filed on Apr. 6, 2020, Application No. 63/046,705 filed on Jul. 1, 2020, and Application No. 63/061,143 filed on Aug. 4, 2020 which are incorporated herein by reference.

### BACKGROUND OF THE INVENTION

### 1. Field of the Invention

The present invention relates to a keyswitch structure, and more particularly to a keyswitch support connection structure of a keyswitch structure.

### 2. Description of the Prior Art

A keyboard keyswitch structure of general notebooks usually uses a scissors-type support for providing a supporting and lifting mechanism for its keycap. Both the keycap and bottom plate of the keyswitch structure are provided with a structure connected to the supports of the supporting and lifting mechanism. The keycap is usually a single structure, such as a plastic injection molded part. In order for sufficient rigidity to withstand a user's pressing and maintain the stability of the connection with the support through the connection structure, the keycap needs to have a certain thickness in the vertical direction. When the keyswitch structure is reduced in size, it is difficult to maintain the rigidity of the entire keycap. The structural characteristics of the above keycap are not conducive to the thin design of the keyswitch structure. In the structural design of the bottom plate, for saving space, the bottom plate is usually used directly to forma structure used for connecting with the support, so that the support can be rotatably connected to the bottom plate. The bottom plate is generally formed by stamping a metal plate to form the connection structure. However, the dimensional accuracy of the connection structure bent through the method is not easy to control, and the strength of the connection structure and the surface area in contact with the support are limited by the thickness of the metal plate, which affects the stability of operation of the keyswitch structure operation. If a connection structure for connecting with the support is formed on the bottom plate by insert molding, the joining strength between the connection structure and the bottom plate is achieved through structural interlocking in principle. When the keyswitch structure is reduced in size, the size of the connection structure will be smaller. It is difficult to maintain the joining strength between the connection structure and the bottom plate. During replacing the keycap and the support, the connection structure will be pulled by the support and the bottom plate, which makes the plastic connection structure easy to deformed or even broken, and cannot be used again.

### SUMMARY OF THE INVENTION

An objective of the invention is to provide a keyswitch support connection structure, which can be structurally integrated into the keycap or base of a keyswitch structure for a keyswitch support to connect. The keyswitch support connection structure uses a combined structure to increase the flexibility of the structural design to obtain the required structural rigidity and stability.

A keyswitch support connection structure of an embodiment according to the invention includes a structural plate and a joining portion. The structural plate includes a protruding portion, a through hole, and at least one side hole. The protruding portion protrudes from a side of the structural plate and forms a recess at another side of the structural plate. The through hole passes through a top surface of the protruding portion. The at least one side hole passes through a side wall of the protruding portion. The joining portion fills up the recess, the through hole, and the at least one side hole. The joining portion includes a hook arm formed on the protruding portion for forming a support connection portion. A vertical projection of the hook arm is located within the top surface of the protruding portion. Thereby, the joining portion is in close contact with the protruding portion through the through hole and the side hole to be firmly combined with the structural plate, so that the support connection portion can obtain a good structural strength. The structural plate and the joining portion can be made of different materials, so that the keyswitch support connection structure can easily obtain sufficient rigidity, and the support connection portion can also provide a stable connection for a keyswitch support.

A keyswitch support connection structure of another embodiment according to the invention includes a structural plate and a joining portion. The structural plate includes a protruding portion, a joining hole, and a cantilever plate. The protruding portion protrudes from a side of the structural plate and forms a recess at another side of the structural plate. The joining hole is located between the protruding portion and the cantilever plate. The joining portion fills up the joining hole and the recess. The joining portion includes a first hook arm and a second hook arm. The first hook arm is formed on the protruding portion. The second hook arm encapsulates the cantilever plate, the first hook arm and the second hook arm being used for forming a support connection portion. Thereby, the joining portion is in close contact with the protruding portion through the protruding portion, the joining hole, and the cantilever plate to be firmly combined with the structural plate, so that the support connection portion can obtain a good structural strength. The structural plate and the joining portion can be made of different materials, so that the keyswitch support connection structure can easily obtain sufficient rigidity, and the support connection portion can also provide a stable connection for a keyswitch support.

A keyswitch support connection structure of another embodiment according to the invention includes a structural plate and a joining portion. The structural plate includes a protruding portion, a through hole, a protruding bridge portion, and a cantilever plate. The protruding portion protrudes form a side of the structural plate and forms a recess at another side of the structural plate. The through hole, the protruding bridge portion, and the cantilever plate are located on a top surface of the protruding portion. The through hole is located between the protruding bridge portion and the cantilever plate. The joining portion fills up the through hole and the recess. The joining portion includes a first hook arm and a second hook arm. The first hook arm encapsulates the protruding bridge portion. The second hook arm encapsulates the cantilever plate. The first hook arm and the second hook arm are used for forming a support connection portion. Thereby, the joining portion is in close contact with the protruding portion through the through hole, the protruding bridge portion, and the cantilever plate to be firmly combined with the structural plate, so that the support connection portion can obtain a good structural strength. The structural plate and the joining portion can be made of different materials, so that the keyswitch support connection structure can easily obtain sufficient rigidity, and the support connection portion can also provide a stable connection for a keyswitch support.

Another objective of the invention is to provide a keyswitch structure, which has one of the above keyswitch support connection structures. The keyswitch support connection structure uses a combined structure to increase the flexibility of the structural design to obtain the required structural rigidity and stability, so as to increase the flexibility design of the keyswitch structure.

A keyswitch structure of an embodiment according to the invention includes a base, a keycap, a first keyswitch support, and a second keyswitch support. The keycap is disposed above the base. The first keyswitch support and the second keyswitch support are connected to and between the keycap and the base, so that the keycap is vertically movable relative to the base through the first keyswitch support and the second keyswitch support. The keyswitch structure includes one of the above keyswitch support connection structures, structurally integrated into the base or the keycap. The first keyswitch support and the support connection portion are connected. Thereby, the structural plate and the joining portion can be made of different materials, so that the keyswitch support connection structure can easily obtain sufficient rigidity, and the support connection portion and the first keyswitch support are stably connected. Furthermore, when the keyswitch support connection structure is structurally integrated into the keycap, the keycap can also use the characteristics of the combination structure to easily obtain sufficient rigidity.

Compared with the prior art, in the keyswitch support connection structure and the keyswitch structure according to the invention, the keyswitch support connection structure is a combination structure, so the structural plate and the joining portion can be made of different materials to easily obtain sufficient rigidity so that the flexibility of the structural design of the keyswitch support connection structure and the keyswitch structure can be increased. Furthermore, by the protruding portion, the through hole, the side hole, the joining hole, the cantilever plate, and the protruding bridge portion which are located on the structural plate, the bonding strength between the joining portion and the structural plate can be increased, and the support connection portion can have a good structural strength. Thereby, the keyswitch support connection structure and the keyswitch structure according to the invention can solve or improve the design problem of the structure used for connecting with the support in the prior art, so the keyswitch support connection structure and the keyswitch structure are more suitable for thin design.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded view of a keyswitch structure according to a first embodiment.

FIG. 2 is an enlarged view of the circle A in FIG. 1.

FIG. 3 is an exploded view of the base in FIG. 2.

FIG. 4 is a sectional view of the base along the line X-X in FIG. 2.

FIG. 5 is a sectional view of the base along the line Y-Y in FIG. 2.

FIG. 6 is an enlarged view of the circle B in FIG. 1.

FIG. 7 is an exploded view of the base in FIG. 6.

FIG. 8 is a sectional view of the base along the line Z-Z in FIG. 6.

FIG. 9 is a sectional view of the base along the line W-W in FIG. 6.

FIG. 10 is a schematic diagram illustrating a cantilever plate of a base according to a second embodiment.

FIG. 11 is a schematic diagram illustrating a cantilever plate of a base according to a third embodiment.

FIG. 12 is a schematic diagram illustrating a cantilever plate of a base according to a fourth embodiment.

FIG. 13 is a schematic diagram illustrating a keyswitch support connection structure according to a fifth embodiment.

FIG. 14 is an exploded view of the keyswitch support connection structure in FIG. 13.

FIG. 15 is a sectional view along the line V-V in FIG. 13.

FIG. 16 is a sectional view of a keyswitch support connection structure according to a sixth embodiment.

FIG. 17 is a sectional view of a keyswitch support connection structure according to a seventh embodiment.

FIG. 18 is a sectional view of a keyswitch support connection structure according to an eighth embodiment.

FIG. 19 is a schematic diagram illustrating a keyswitch structure according to a ninth embodiment.

FIG. 20 is a partially exploded view of the keyswitch structure in FIG. 19.

FIG. 21 is a partially exploded view of the keycap of the keyswitch structure in FIG. 20.

FIG. 22 is an enlarged view of the circle A in FIG. 20, in which the balance bracket is not shown.

FIG. 23 is an exploded view of a structural plate and a joining portion of the keycap in FIG. 22.

FIG. 24 is a schematic diagram illustrating the structural plate in FIG. 23 in another view point.

FIG. 25 is a sectional view of the keycap along the line X-X in FIG. 22.

FIG. 26 is a sectional view of the keycap along the line Y-Y in FIG. 22.

FIG. 27 is a schematic diagram illustrating a variant of the structural plate in FIG. 23.

FIG. 28 is a schematic diagram illustrating another variant of the structural plate in FIG. 23.

FIG. 29 is a schematic diagram illustrating another variant of the structural plate in FIG. 23.

FIG. 30 is a schematic diagram illustrating another variant of the structural plate in FIG. 23.

FIG. 31 is an enlarged view of the circle B in FIG. 20, in which the balance bracket is not shown.

FIG. 32 is an exploded view of the structural plate and the joining portion of the keycap in FIG. 31.

FIG. 33 is a sectional view of the keycap along the line Z-Z in FIG. 31.

FIG. 34 is an exploded view of a structural plate and a joining portion according to a tenth embodiment.

FIG. 35 is an exploded view of the structural plate and the joining portion of the keycap at the circle C in FIG. 20.

FIG. 36 is a sectional view of the keycap along the line Z-Z in FIG. 20.

FIG. 37 is an exploded view of the structural plate and the joining portion of the keycap at the circle D in FIG. 20.

FIG. 38 is a partially exploded view of a keyswitch structure according to an eleventh embodiment.

FIG. 39 is an exploded view of a structural plate and a joining portion of the keycap in FIG. 38.

FIG. 40 is a partially exploded view of a keyswitch structure according to a twelfth embodiment.

FIG. 41 is an exploded view of a structural plate and a joining portion of the base in FIG. 40.

### DETAILED DESCRIPTION

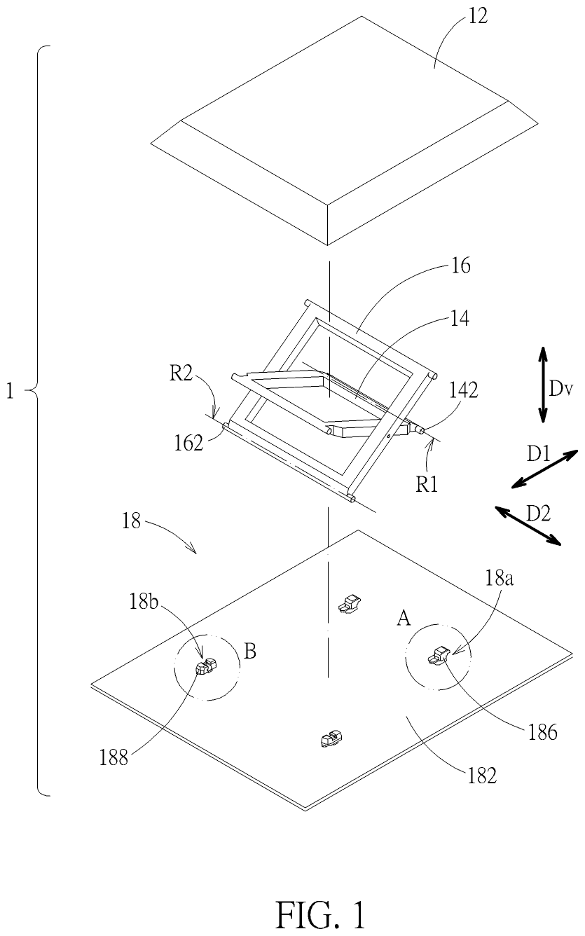

Please refer to FIG. 1. A keyswitch structure 1 according to a first embodiment includes a keycap 12, a first keyswitch support 14, a second keyswitch support 16, and a base 18. The keycap 12 is disposed above the base 18. Both the first keyswitch support 14 and the second keyswitch support 16 are connected to and between the keycap 12 and the base 18, so that the keycap 12 can move vertically relative to the base 18 (or move parallel to a vertical direction Dv, indicated by a double-headed arrow in the figure) through the first keyswitch support 14 and the second keyswitch support 16. Therein, the base 18 includes two support connection portions 18a and two support connection portions 18b. The first keyswitch support 14 is rotatably and slidably connected to the base 18 through the support connection portion 18a. The second keyswitch support 16 is rotatably connected to the base 18 through the support connection portion 18b.

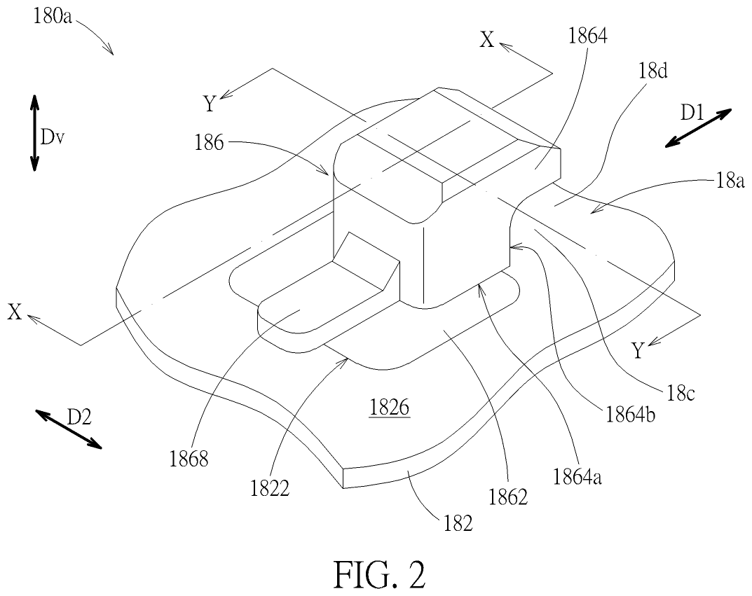

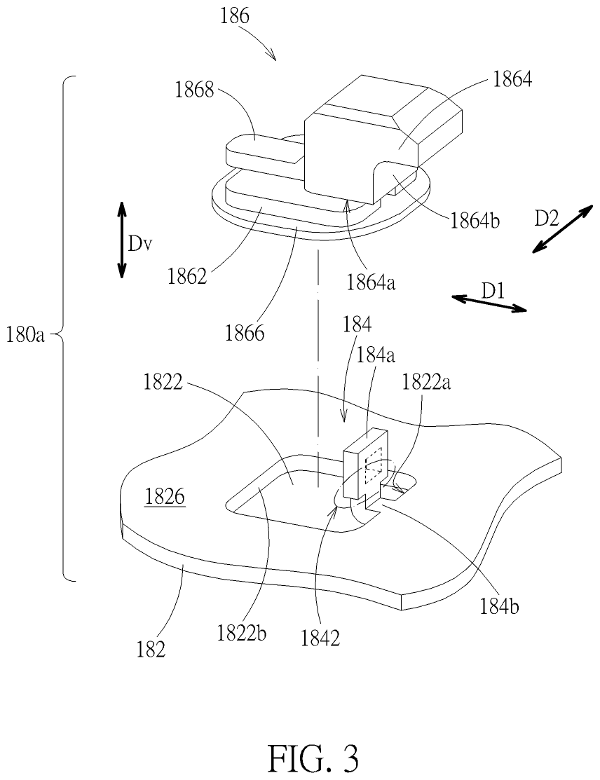

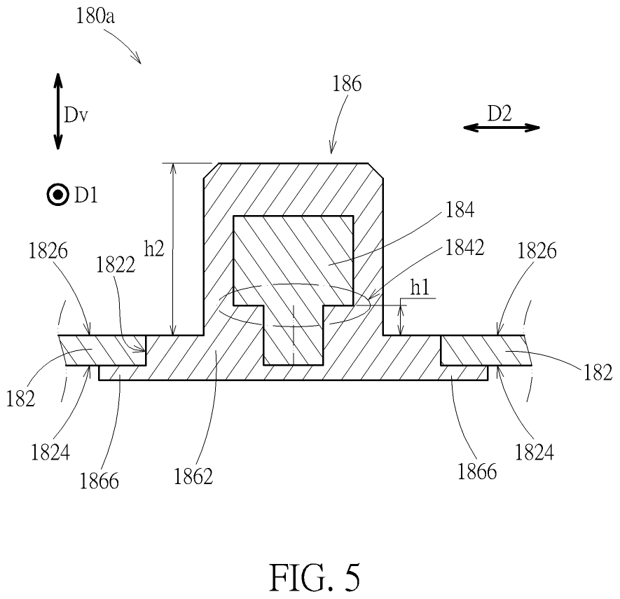

Please also refer FIG. 2 to FIG. 5. For the support connection portion 18a that is connected with the first keyswitch support 14, the base 18 includes a bottom plate portion 182, a cantilever plate 184, and a joining portion 186. The first keyswitch support 14 is rotatably and slidably connected to the bottom plate portion 182 of the base 18 through the support connection portion 18a. The second keyswitch support 16 is rotatably connected to the bottom plate portion 182 of the base 18 through the support connection portion 18b. The bottom plate portion 182 has a joining hole 1822. The cantilever plate 184 herein is a single-planar structure with a substantially vertical middle line, and single-bended extends upward from an edge of the joining hole 1822 and has a holding structure 1842 (indicated by a frame in chain lines in FIG. 3 and FIG. 5). The joining portion 186 and the joining hole 186 are firmly engaged with each other. The joining portion 186 encapsulates the holding structure 1842. The joining portion 186 and the bottom plate portion 182 jointly form the support connection portion 18a. Therein, the combination of the bottom plate portion 182, the cantilever plate 184, and the joining portion 186 can be regarded as one keyswitch support connection structure 180a, used for connecting with the first keyswitch support 14.

In the first embodiment, the cantilever plate 184 has a fixed end 184a and a free end 184b. The cantilever plate 184 is fixed to the bottom plate portion 182 through the fixed end 184a. The holding structure 1842 is a necking portion of the cantilever plate 184 between the fixed end 184a and the free end 184b. The necking portion can increase the surface area of the cantilever plate 184 in contact with the joining portion 186 and the degree of structural interference with the joining portion 186. The bottom plate portion 182 and the cantilever plate 184 are formed by the same pressing part . For example, a metal plate is pressed to form the bottom plate portion 182 and the cantilever plate 184 at the same time. In structural logic, the cantilever plate 184 is formed by bending a portion of the bottom plate portion 182 upward and extending it. The joining portion 186 is an injection part, e.g. formed by plastic injection moulding (inserting the bottom plate portion 182 together with the cantilever plate 184 and injecting plastic).

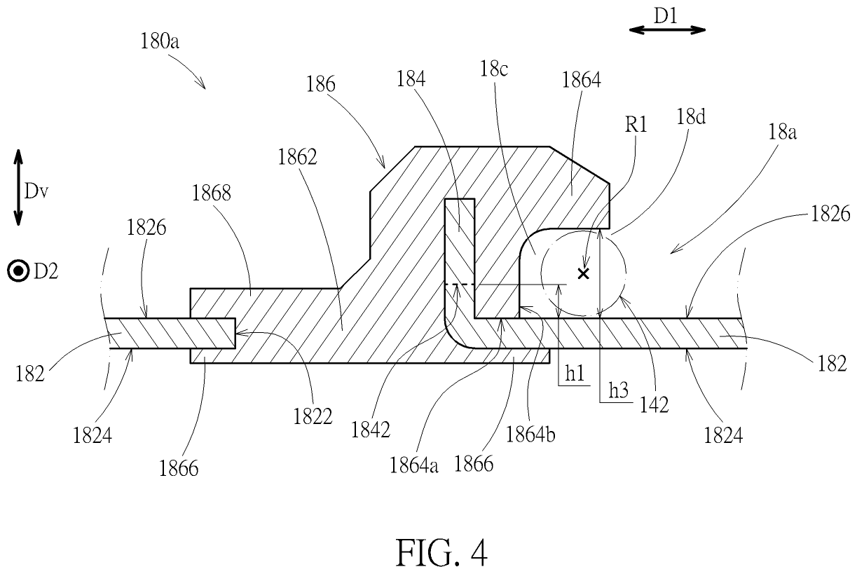

The support connection portion 18a has a sliding slot 18c. Basically the cantilever plate 184 has its plane facing the sliding slot 18c. The sliding slot 18c extends in a first direction D1 (indicated by a double-headed arrow in the figures) parallel to the bottom plate portion 182 and has an opening 18d. The opening 18d is used for a base connection portion 142 of the first keyswitch support 14 (which is indicated by a chain circle in FIG. 4) to enter the sliding slot 18c, so as to be slidably connected with the support connection portion 18a in the first direction D1. The base connection portion 142 of the first keyswitch support 14 also can rotate around a rotation axis R1 (indicated by a chain line in FIG. 1 and by a cross mark in FIG. 4) perpendicular to the first direction D1 and the vertical direction Dv in the sliding slot 18c. The rotation axis R1 is parallel to a second direction D2 (indicated by a double-headed arrow in the figures). Furthermore, the joining hole 1822 has two opposite side edges 1822a and 1822b in the first direction D1. The cantilever plate 184 extends upward from the side edge 1822a (which is closer to the opening 18d than the side edge 1822b). In the view point of FIG. 4, the opening 18d faces rightward. The cantilever plate 184 extends upward from the right side edge of the joining hole 1822. The center position of the first keyswitch support 14 is located at the left side of the support connection portion 18a. When the first keyswitch support 14 is driven to move upward (e.g., by the keycap 12 moving upward to drive the first keyswitch support 14), the base connection portion 142 will pull the joining portion 186 up and to the left. The above structural configuration can increase the resistance of the cantilever plate 184 to this pulling force (i.e., increasing the overall structural strength of the keyswitch support connection structure 180a). In addition, in the embodiment, as shown by FIG. 5, the height h1 of a middle line (indicated by a chain line in FIG. 5) for the holding structure 1842 is not higher than 50% of the height h2 of the joining portion 186; as shown by FIG. 4, the height h1 for the holding structure 1842 (the hidden profile of which is shown by a dashed line) is not higher than a half of a slot height h3 of the sliding slot 18c (which is roughly equal to that the height h1 is not higher than the rotation axis R1).

The joining portion 186 includes an embedded portion 1862, a hook portion 1864, a wing portion 1866, and a rib 1868. The bottom plate portion 182 has a bottom surface 1824 and an upper surface 1826 opposite to the bottom surface 1824 in the vertical direction Dv. The joining hole 1822 passes through the bottom surface 1824 and the upper surface 1826. The embedded portion 1862 fills up the joining hole 1822 and is coplanar with the upper surface 1826. The embedded portion 1862 is integrally connected with the wing portion 1866 downward and is integrally connected with a bottom end 1864a of the hook portion 1864 and the bottom of the rib 1868 upward. The hook portion 1864 is inverted L-shaped. The hook portion 1864 and the upper surface 1826 jointly form the support connection portion 18a, so the support connection portion 18a is located on the side of the upper surface 1826. The sliding slot 18c of the support connection portion 18a is jointly defined by an inverted L-shaped wall surface 1864b of the hook portion 1864 of the joining portion 186 and the upper surface 1826 of the bottom plate portion 182 adjoining the wall surface 1864b. As described above, the sliding slot 18c has an opening 18d in the first direction D1, and the sliding slot 18c and the hook portion 1864 are also open on opposite sides in the second direction D2. The wing portion 1866 protrudes from the bottom surface 1824 and covers a portion of the bottom surface 1824 (or extends on the bottom surface 1824). The rib 1868 is located at the back side of the hook portion 1864 (i.e., the side opposite to the opening 18d). The width of the rib 1868 can be selectively not greater than the width of the hook portion 1864 or the width of the joining portion 186. The rib 1868 extends outward parallel to the first direction D1 beyond the side edge 1822b of the joining hole 1822. The rib 1868 extends at least partially to cover the upper surface 1826 of the bottom plate portion 182. Similarly the height of the rib 1868 can be selectively not greater than 75% the total height of the joining portion 186.

The wing portion 1866 is conducive to not only increasing the bonding strength between the joining portion 186 and the bottom plate portion 182, but also aiding the joining portion 186 in resisting separating from the bottom plate portion 182 (e.g., when the base connection portion 142 of the first keyswitch support 14 pulls the joining portion 186 upward and to the left). In order to prevent the joining portion 186 from being partially upwardly deformed or overturned when pulled by an external force, the rib 1868 is provided to help increase the overall structural strength of the joining portion 186, so that when the joining portion 186 is subjected to the upward external force, the rib 1868 can abut against the side edge 1822b of the joining hole 1822 and the portion of the upper surface 1826 adjacent to the side edge 1822b. It also helps the joining portion 186 to resist separating from the bottom plate portion 182. Besides, the bottom end 1864a of the hook portion 1864 at least partially extends and covers the upper surface 1826 of the bottom plate portion 182 beside the joining hole 1822. Thereby, before being deformed or turned over by an upward external force, the joining portion 186 can abut against the hole wall of the joining hole 1822 and the portion of the upper surface 1826 adjacent to the hole wall through the bottom end 1864a of the hook portion 1864, so as to avoid separating from the bottom plate portion 182.

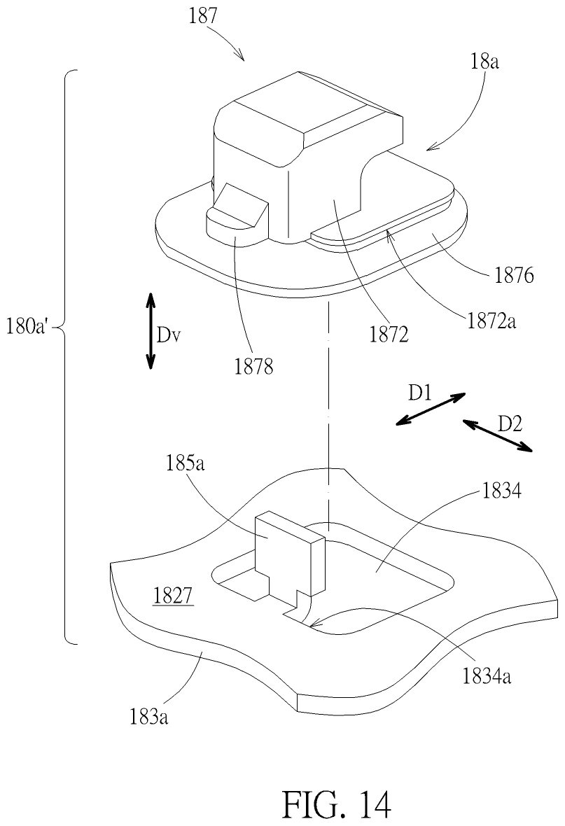

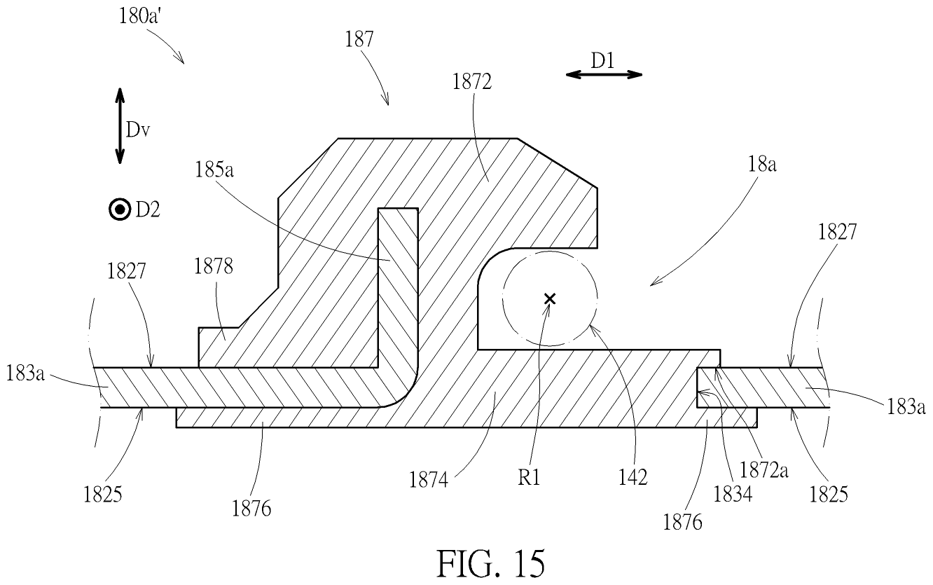

Furthermore, in the first embodiment, the wing portion 1866 is provided on the portion of the bottom surface 1824 surrounding the joining hole 1822; that is, the wing portion 1866 extends from the joining hole 1822 around and covers the bottom surface 1824. Therefore, the wing portion 1866 extends on the bottom surface 1824 perpendicular to the rotation axis R1 (i.e., parallel to the first direction D1). The wing portion 1866 can also extend on the bottom surface 1824 parallel to the rotation axis R1 (i.e., parallel to the second direction D2) as required. In order to prevent the joining portion 186 from being partially upwardly deformed or overturned when pulled by an external force, the above structural configuration makes the wing portion 1866 be able to help the joining portion 186 to resist separating from the bottom plate portion 182 in all directions; however, it is not limited thereto. For example, the wing portion 1866 extends on the bottom surface 1824 only parallel to the first direction D1. This structural configuration makes the joining portion 186 abut against the portion of the bottom surface 1824 around the joining hole 1822 through the wing portion 1866 when being subjected to an upward external force, which can increase the resistance of the joining portion 186 against the separation from the bottom plate portion 182. For another example, the wing portion 1866 extends on the bottom surface 1824 only parallel to the first direction D1 toward the opening 18d, which can also increase the resistance of the joining portion 186 against the separation from the bottom plate portion 182 to a certain extent. The wing portion 1866 provides extra pulling strength, also because when the position of the bottom plate portion 182 where the wing portion 1866 is disposed is a flat surface as the flat bottom surface 1824, better be flat at both upper and bottom surfaces 1826 and 1824. If the bottom plate portion 182 is punched to form a holding recess where the wing portion 1866 is disposed, the punched area of the bottom plate portion 182 accumulates certain stress and becomes structurally weaker. Therefore the wing portion 1866 should extend outwards to an outer flat area of the bottom surface 1824 (outside the holding recess). Such flat area has both upper and bottom surfaces 1826 and 1824 be flat and unprocessed. Furthermore, the wing portion 1866 provides extra pulling strength if there has at least a corresponding part of the joining portion 186 is overlapped with the wing portion 1866 in vertical projection. That means the wing portion 1866 and such corresponding part of the joining portion 186 jointly holds a flat area of the bottom plate portion 182, by attaching to a corresponding flat part of the upper surface 1826 and bottom surface 1824. The corresponding part of the joining portion 186 may be the ribs 1868 and 1878 in FIGS. 2-4 and FIGS. 13-15. It is also important that at least a portion of the wing portion 1866 extend outwards in excess of the vertical projection of the main body of various joining portions 186, 187 and 188 (e.g. the hook portions 1864, 1872, 1881a and 1881b) to provide additional pulling strength.

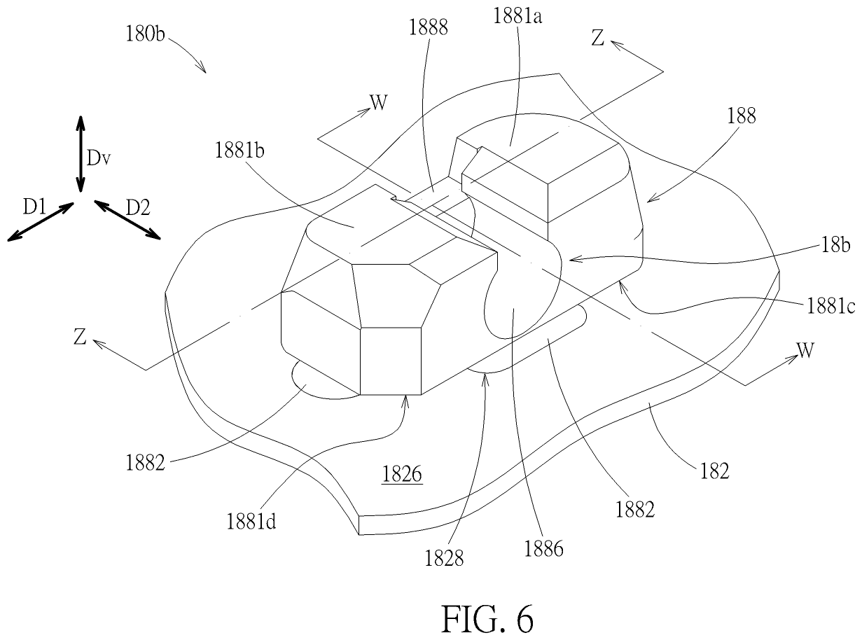

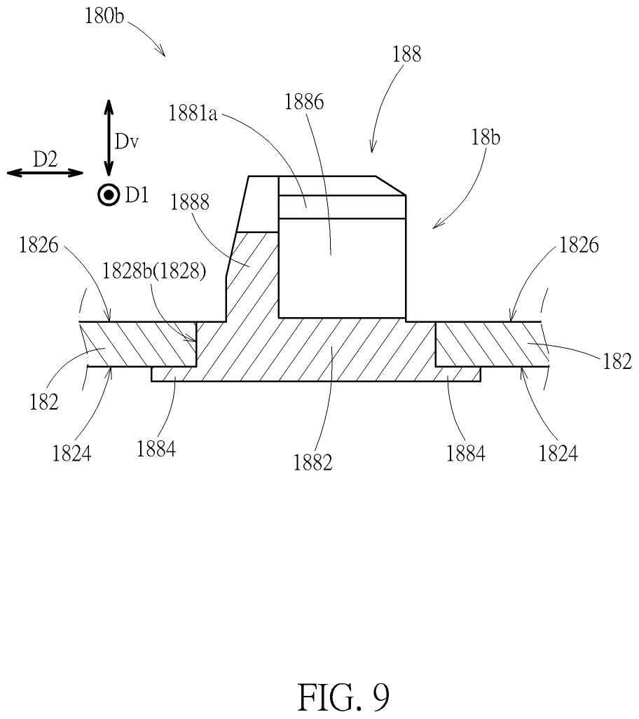

Please refer to FIG. 1, FIG. 6 to FIG. 9. For the support connection portion 18b, the base 18 includes a joining portion 188, alone forming the support connection portion 18b. The bottom plate portion 182 has a joining hole 1828 and two protruding bridge portions 1830. The joining hole 1828 extends in the first direction D1, and the two protruding bridge portions 1830 extend in the second direction D2. The two protruding bridge portions 1830 are disposed opposite to each other at an interval in the first direction D1 and are higher than the upper surface 1826 of the base 18. Each protruding bridge portions 1830 is connected across to two sides of the joining hole 1828, so that the joining hole 1828 is divided into three portions (from the view in the vertical direction Dv). That is, the two protruding bridge portions 1830 divide the joining hole 1828 into three exposed holes in the first direction D1, namely a side hole 1828a, a middle hole 1828b and a side hole 1828c respectively. Therein, the side hole 1828a and the middle hole 1828b are connected by the space under one protruding bridge portion 1830, and the middle hole 1828b and the side hole 1828c are connected by the space under the other protruding bridge portion 1830. The embedded portion 1862 fills up the side hole 1828a, the middle hole 1822b, the side hole 1822c, and the above two connection spaces. The joining portion 188 and the joining hole 1828 are firmly engaged with each other. The joining portion 188 encapsulates the two protruding bridge portions 1830; therein, the combination of the bottom plate portion 182 and the joining portion 188 can be regarded as one keyswitch support connection structure 180b, used for connecting with the second keyswitch support 16.

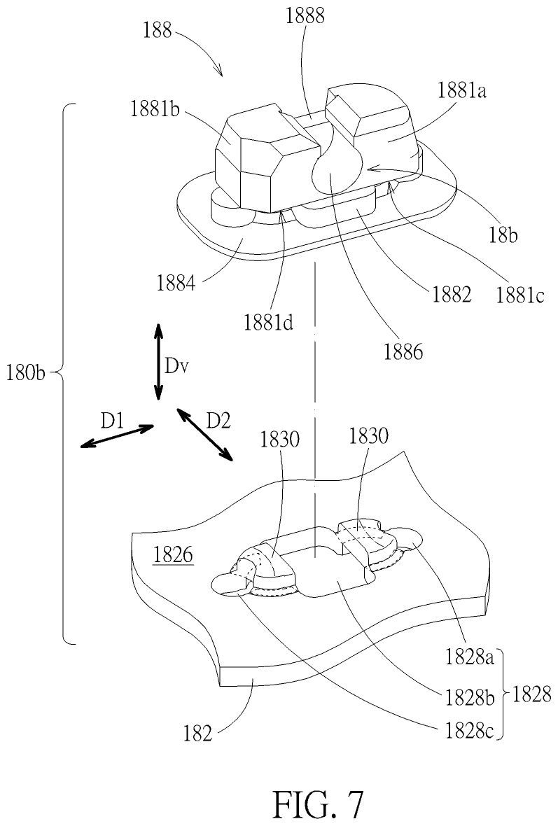

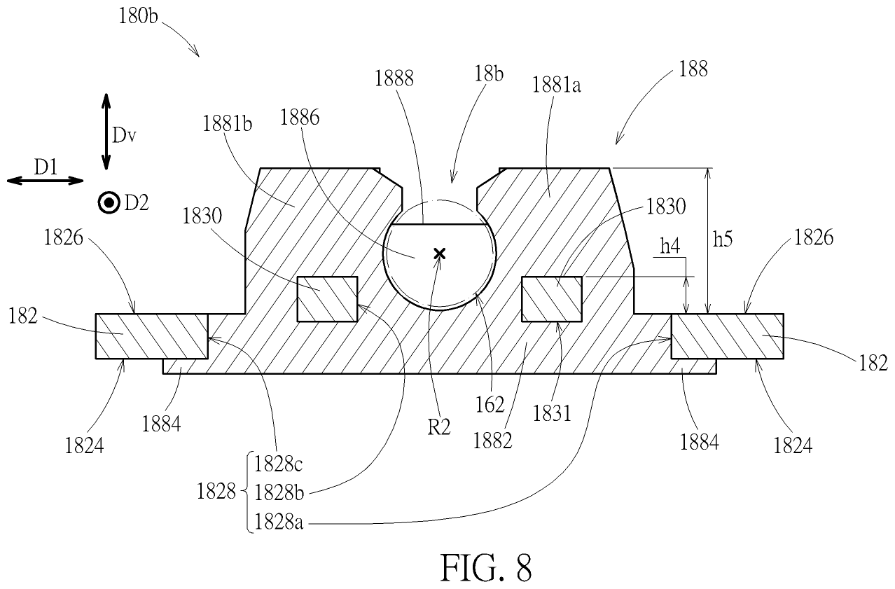

In the embodiment, a shaft-shaped base connection portion 162 of the second keyswitch support 16 (which is indicated by a chain circle in FIG. 8) is pivotally connected to the joining portion 188, so that the second keyswitch support 16 can rotate around a rotation axis R2 (indicated by a chain line in FIG. 1 and by a cross mark in FIG. 8) perpendicular to the vertical direction Dv (i.e. rotating parallel to the rotation axis R2). The rotation axis R2 is parallel to the second direction D2. The two protruding bridge portions 1830 are arranged in a direction perpendicular to the rotation axis R2 (and the vertical direction Dv). The connection interfaces (shown by frames in dashed lines in FIG. 7) between the protruding bridge portion 1830 and the joining hole 1828 are not rectangular, but curved; it can increase the moment of inertia of the protruding bridge portion 1830. If the outsides of the two protruding bridge portions 1830 are closed, i.e., there is no the two side holes 1828a and 1828c, the stress is more likely to concentrate on the periphery of the middle hole 1828b when the joining portion 188 is pulled by a force, especially on the opposite inner edges of the two protruding bridge portions 1830, which makes the two protruding bridge portion 1830 easily deform due to the high stress. Therefore, the disposition of the two side holes 1828a and 1828c helps to disperse the stress locally from the periphery of the middle hole 1828b to the periphery of the two side holes 1828a/1828c. Furthermore, the widths of the two side holes 1828a and 1828c in the second direction D2 are not greater than that of the middle hole 1828b, which can effectively disperse the stress to the two side holes 1828a and 1828c when the joining portion 188 is pulled by a force. In the view point of FIG. 8, the central position of the second keyswitch support 16 is located at the right side of the support connection portion 18b. When the second keyswitch support 16 is driven to move upward (e.g., by the keycap 12 moving upward to drive the second keyswitch support 16), the base connection portion 162 will pull the joining portion 188 up and to the left. The above protruding bridge portion 1830 with the curved connection interface can increase the resistance of the protruding bridge portion 1830 to this pulling force (i.e., increasing the overall structural strength of the keyswitch support connection structure 180b). In addition, the height of the protruding bridge portion 1830 with the same width thereof may be close to the upper surface 1826 to avoid lowering its pulling strength. For example, as shown in FIG. 8, the bottom surface of the protruding bridge portion 1830 may be lower than the upper surface 1826 to maintain a high pulling strength under a certain width of the protruding bridge portion 1830. In addition, in the embodiment, as shown by FIG. 8, a height h4 of a middle line (indicated by a chain line in FIG. 7) for the protruding bridge portion 1830 is not higher than 50% of a height h5 of the joining portion 188, and not higher than a rotation axis (equivalent to the rotation axis R2) of the shaft recess 1886. The bottom surface 1831 of the protruding bridge portion 1830 is lower than the upper surface 1826 of the bottom plate portion 182.

The joining portion 188 includes two hook portions 1881a and 1881b, an embedded portion 1882, and a wing portion 1884. The two hook portions 1881a and 1881b disposed opposite to each other at an interval in the first direction D1. The two opposite concave wall surfaces of the two hook portions 1881a and 1881b jointly define a shaft recess 1886. The shaft recess 1886 extends in the second direction D2 (or the rotation axis R2). The shaft recess 1886 is at least partially open in the second direction D2 (or the rotation axis R2) and the vertical direction Dv. The size of the shaft recess 1886 at the opening in the vertical direction Dv, i.e., the distance between free ends of the hook portions 1881a and 1881b, is slightly smaller than the diameter of the shaft structure of the base connecting portion 162 of the second key switch support 16. The bottom ends 1881c and 1881d of the two hook portions 1881a and 1881b, extends at least partially to cover and adhere to the upper surface 1826. Thereby, when the joining portion 186 is pulled upward by an external force, the bottom ends 1881c and 1881d of the two hook portions 1881a and 1881b abut against the hole wall of the joining hole 1828 (including the side hole 1828a, the middle hole 1828b, and the side hole 1828c) and the portion of the upper surface 1826 adjacent to the joining hole 1828, so as to resist separation of the joining portion 186 from the bottom plate portion 182. The embedded1882 fills up the joining hole 1828. The wing portion 1884 protrudes from the bottom surface 1824 and covers a portion of the bottom surface 1824 (or extends on the bottom surface 1824). The structure and effect of the wing portion 1884 of the joining portion 188 is the same as the wing portion 1866 of the joining portion 186. For other descriptions about the wing portion 1884 of the joining portion 188, please refer to the relevant descriptions of the wing portion 1886 of the joining portion 186 and variants thereof, which will not be repeated in addition. The shaft recess 1886 is rotatably connected to the base connection portion 162. In other words, the joining portion 188 independently achieves the support connection portion 18b through the shaft recess 1886. Furthermore, the joining portion 188 includes aside wall 1888 beside the shaft recess 1886 in the rotation axis R2. The side wall 1888 connects the two hook portions 1881a and 1881b, which can increase the structural stability between the two hook portions 1881a and 1881b inducing an improvement in the structural strength of the shaft recess 1886 and can also improve the stability of the pivotal connection between the joint 188 and the base connection 162.

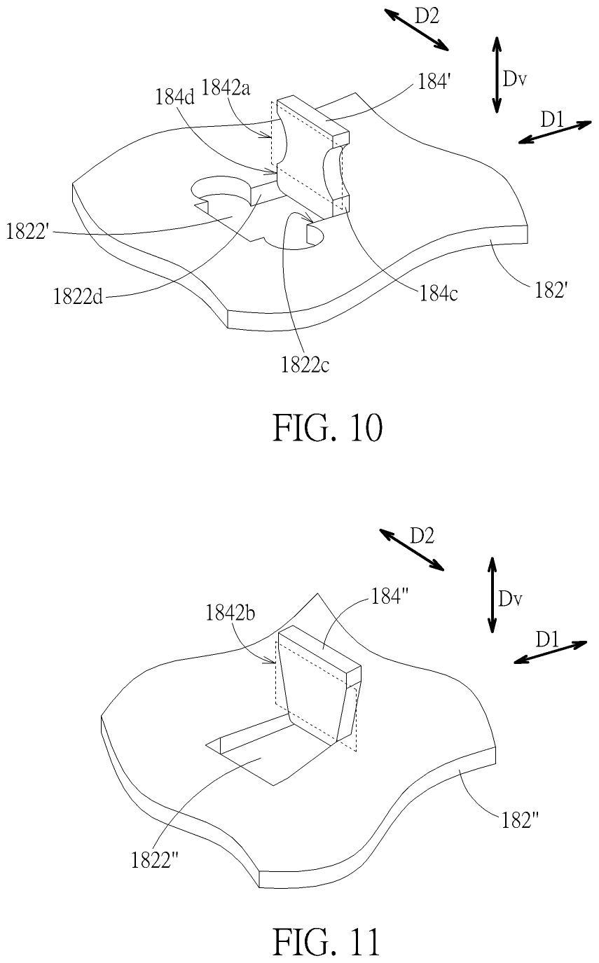

In addition, in the embodiment, as shown by FIG. 3, the cantilever plate 184 has an L-shaped neck portion extending from the bottom plate portion 182 and bending upward, and a head portion connected to the L-shaped neck portion. A step between the head portion and the neck portion that is formed due to the different widths of the head portion and the neck portion can be regarded as the necking portion in structure (as the holding structure 1842). In practice, the necking portion also can be achieved by other structures. For example, as shown by FIG. 10, the necking portion of a cantilever plate 184′ according to a second embodiment is formed by two notches at two sides of the cantilever plate 184′ and is regarded as a holding structure 1842a (indicated by a frame in chain lines in the figure). Furthermore, in FIG. 10, the cantilever plate 184′ has two opposite outer edges 184c and 184d from its fixed end to its free end (i.e., in the direction perpendicular to the extension direction thereof). A joining hole 1822′ of the bottom plate portion 182′ has two opposite side edges 1822c and 1822d in a direction perpendicular to the first direction D1. The two outer edges 184c and 184d are directly connected to the two side edges 1822c and 1822d respectively. Such structural feature is conducive to increasing the structural strength of the cantilever plate 184′ itself. For another example, as shown by FIG. 11, a cantilever plate 184″ according to a third embodiment includes an inverted trapezoid structure, the width of which decreases from top to bottom. Therefore, the entire inverted trapezoidal structure can be regarded as a necking portion to be used as a holding structure 1842b (indicated by a frame in chain lines in the figure). Furthermore, in FIG. 11, the profile of a joining hole 1822″ of the bottom plate portion 182″ is the same as the profile of the cantilever plate 184″ (for example by directly punching a sheet metal parts without leaving any clearance). Such structural feature can reduce the plate area of the base 18 occupied by the joining hole 1822″ and the joining portion (not shown in FIG. 11; please refer to the joining portions 18a and 18b in FIG. 1 to FIG. 9), reduce the volumes of the joining portions 18a and 18b, reduce the interference between the joint portions 18a and 18b and other components, and increase the structural strength of the cantilever plate 184″ itself.

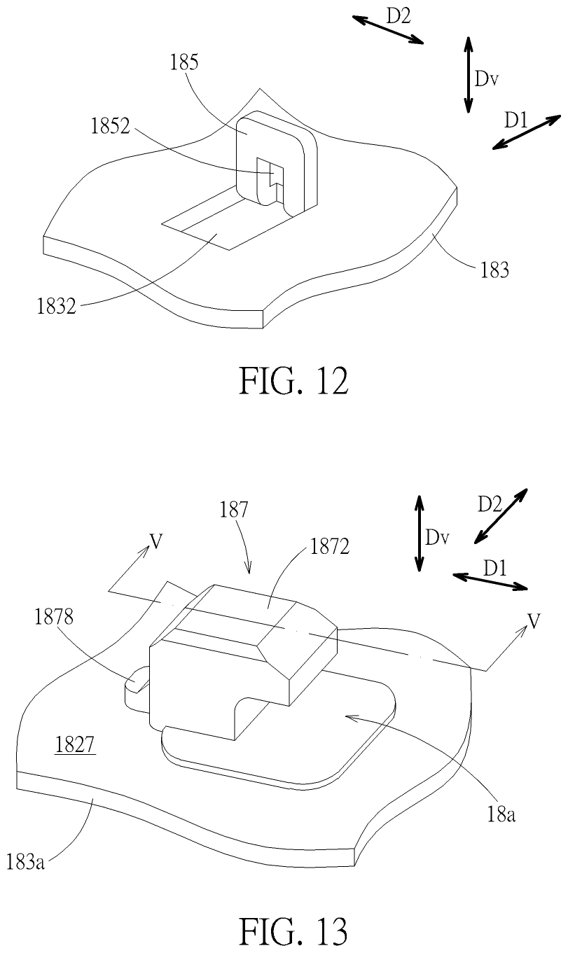

Furthermore, in the first embodiment, as shown by FIG. 3, the holding structure 1842 increases its bonding strength with the joining portion 186 through a necking portion; however, it is not limited thereto in practice. For example, as shown by FIG. 12, a holding structure 1852 of a cantilever plate 185 according to a third embodiment includes a through hole (passing through the cantilever plate 185 parallel to the bottom plate portion 183). The holding structure 1852 increases its bonding strength with the joining portion 186 (in FIG. 3) through the through hole. The through hole can also be applied to the head of the cantilever plate 184 (as shown by the dashed lines in FIG. 3). Furthermore, as shown in FIG. 12, the profile of the cantilever plate 185 is the same as the joining hole 1832 of the bottom plate portion 183, which is conducive to increasing the structural strength of the cantilever plate 185.

In addition, in the first embodiment, as shown by FIG. 2 and FIG. 4, the joining portion 186 and the bottom plate portion 182 jointly form the support connection portion 18a ; however, it is not limited thereto in practice. For example, as shown by FIG. 13 to FIG. 15, a joining portion 187 according to a fifth embodiment has a hook portion 1872, an embedded portion 1874, and a wing portion 1876 which are connected up and down. The hook portion 1872 has a contacting surface 1872a at its bottom and at least partially closely adheres to an upper surface 1827 of the bottom plate portion 183a through the contacting surface 1872a. The embedded portion 1874 fills up the joining hole 1834 of the bottom plate portion 183a. The wing portion 1876 closely adheres to a bottom surface 1825 of the bottom plate portion 183a. The projection of the contacting surface 1872a in the vertical direction Dv is located within the projection of the wing portion 1876 in the vertical direction Dv. Thereby, even if the wing portion 1876 is thin, the large distribution area of the wing portion 1876 can still increase the resistance of the joining portion 187 against the separation from the bottom plate portion 183a. Furthermore, in this embodiment, the joining portion 187 independently forms the support connection portion 18a (in which the combination of the bottom plate portion 183a, the cantilever plate 185a, and the joining portion 187 can be regarded as one keyswitch support connection structure 180a′). Furthermore, the cantilever plate 185a extends upward from a side edge 1834a of the joining hole 1834 of the bottom plate portion 183a that is relatively away from the opening direction of the hook portion 1872 in the first direction Dl. The joining portion 187 includes a rib 1878 extending in the first direction at its rear side. The rib 1878 adheres to the upper surface 1827 of the bottom plate portion 183a. The rib 1878 is not located within the projection of the joining hole 1834, and is not connected with the embedded portion 1874 that fills up the joining hole 1834, but the rib 1878 and a part of the wing portion 1876 jointly clamp the bottom plate portion 183a up and down. The ribs 1868 and 1878 may has a width narrower than the joining portions 186 and 187 to save space for better accommodating the first and second keyswitch supports 14 and 16 when the keycap 12 moves downwards.

In addition, in the first embodiment, the structure (including one cantilever plate 184) for joining the joining portion 186 (used for forming the keyswitch support connection structure 180a) with the bottom plate portion 182 is not the same as the structure (including two protruding bridge portions 1830) for joining the joining portion 188 (used for forming the keyswitch support connection structure 180b) with the bottom plate portion 182; however, it is not limited thereto in practice. For example, for the support connection portion 18a, the cantilever plate 184 and the wing portion 1866 of the joining portion 186 can be implemented alternatively. For the support connection portion 18a, the bottom plate portion 182 can be provided with a structure like the protruding bridge portion 1830 at the left side of the joining hole 1822; therein, the joining portion 186 also encapsulates the structure. For another example, for the support connection portion 18a, the cantilever plate 184 is replaced with a structure like the protruding bridge portion 1830 (spanning the joining hole 1822); therein, the joining portion 186 also encapsulates the structure. For another example, for the support connection portion 18b, one or two protruding bridge portions 1830 are structures like the cantilever plate 184 (or variants thereof) respectively (extending upwards from both sides of the joining hole 1828 respectively); therein, the joining portion 188 also encapsulates the structure.

Specifically, the above-mentioned cantilever plates 184, 184′, 184″, 185 and 185a of the above embodiments are not limited to applied to the support connection portion 18a or joining portions 186 and 187 of the above embodiments. The cantilever plates 184, 184′, 184″, 185 and 185a also can be applied to the support connection portion 18b or joining portion 188 in FIG. 6 to FIG. 9.

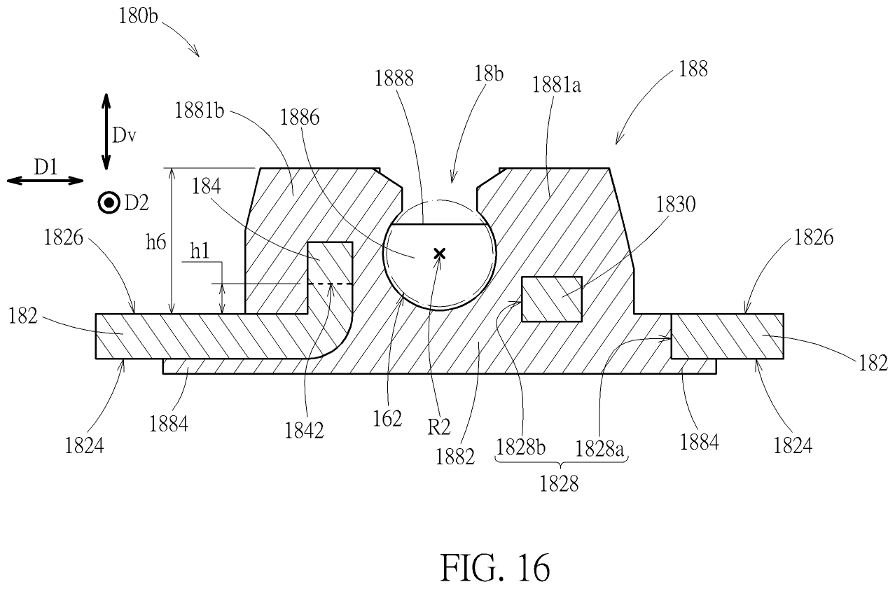

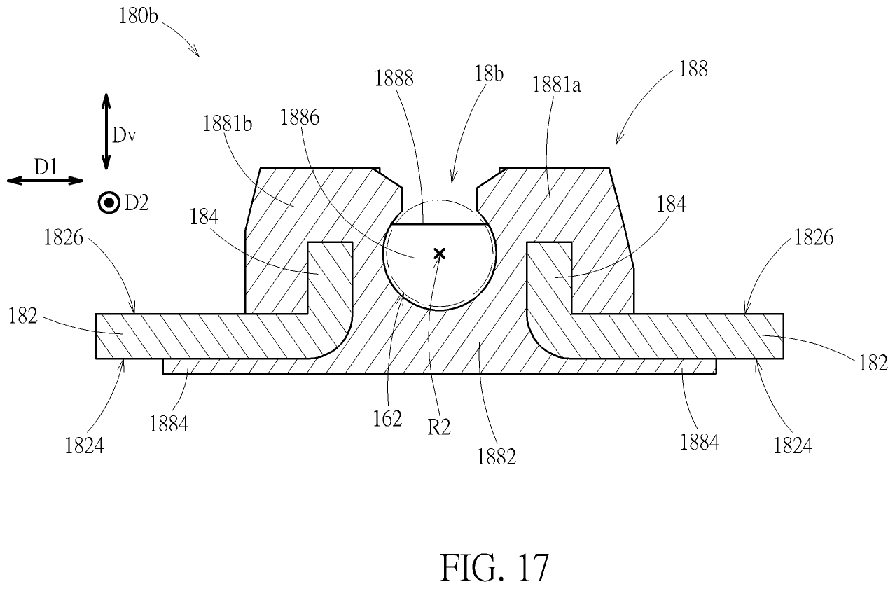

Please refer to FIG. 16 and FIG. 17, which are sectional views of sixth and seventh embodiments respectively, and of which the positions of the cutting plans are equivalent to the line Z-Z in FIG. 6. In FIG. 16 and FIG. 17, most of the components correspond to those of the embodiment shown by FIG. 8. The components and structures with the same component names or reference numbers have the same or similar technical features, which will not be repeated herein.

In FIG. 16, the left protruding bridge portion 1830 in FIG. 8 is replaced with one of the cantilever plates 184, 184′, 184″, 185 and 185a. That is, the hook portion 1881a and the embedded portion 1882 still encapsulate the entire right the protruding bridge portion 1830, and the hook portion 1881b is changed to encapsulate the entire cantilever plate 184 on the left in FIG. 16 (or one of the cantilever plates 184′, 184″, 185 and 185a). The cantilever plate 184 (or 184′, 184″, 185 and 185a) bends from the first direction D1 to the vertical direction Dv and extends. Similarly, the height h1 for the holding structure 1842 (the hidden profile of which is shown by a dashed line) is not higher than 50% of the height h6 of the joining portion 188; the height h1 for the holding structure 1842 is not higher than a rotation axis (equivalent to the rotation axis R2) of the shaft recess 1886.

The structural configuration shown by FIG. 16 makes the joining portion 188 with two hook portions 1881a and 1881b join with the bottom plate portion 182 through one cantilever plate 184 (or 184′, 184″, 185 and 185a) and one protruding bridge portion 1830. Basically the cantilever plate 184 (or 184′, 184″, 185 and 185a) has its plane face the shaft recess 1886 and the protruding bridge portion 1830, with the shaft recess 1886 formed between the cantilever plate 184 (or 184′, 184″, 185 and 185a) and the protruding bridge portion 1830. The support connection portion 18b formed by the two hook portions 1881a and 1881b of the joining portion 188 can provide high-strength pull-out resistance through the cantilever plate 184 (or 184′, 184″, 185 and 185a) and the protruding bridge portion 1830.

Similarly, in FIG. 17, each of the two protruding bridge portions 1830 in FIG. 8 are replaced with one of the cantilever plates 184, 184′, 184″, 185 and 185a. The hook portion 1881a, the hook portion 1881b, and the embedded portion 1882 completely encapsulate the two cantilever plates 184 (or 184′, 184″, 185 and 185a). Each cantilever plate 184 (or 184′, 184″, 185 and 185a) bend from the first direction D1 to the vertical direction Dv and extend. Basically the two cantilever plates 184 (or 184′, 184″, 185 and 185a) have their planes face each other and meanwhile both face the shaft recess 1886 between the two cantilever plates 184 (or 184′, 184″, 185 and 185a).

The structural configuration shown by FIG. 17 makes the joining portion 188 with two hook portions 1881a and 1881b join with the bottom plate portion 182 through two cantilever plates 184 (or 184′, 184″, 185 and 185a). The support connection portion 18b formed by the two hook portions 1881a and 1881b of the joining portion 188 can provide high-strength pull-out resistance through the two cantilever plates 184 (or 184′, 184″, 185 and 185a).

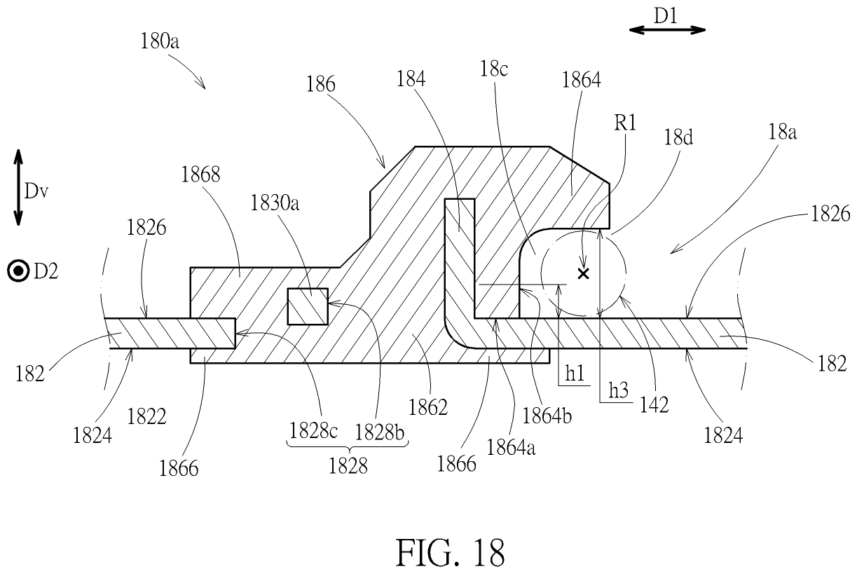

Please refer to FIG. 18, which is a sectional view of an eighth embodiment, and of which the position of the cutting plan is equivalent to the line X-X in FIG. 2. FIG. 18 is roughly similar to the embodiment corresponding to FIG. 4. The difference relative to FIG. 4 is that the joining hole 1822 (referring FIG. 4) is further provided with a protruding bridge portion 1830a (i.e., the protruding bridge portion 1830 in FIG. 7 and FIG. 8). The protruding bridge portion 1830a is connected across two sides of the joining hole 182, which divides the joining hole 1822 into two portions from the view in the vertical direction Dv. That is, the protruding bridge portion 1830a divides the joining hole 1822 into exposed middle hole 1822b and side hole 1822c in the first direction D1. The middle hole 1822b and the side hole 1822c are connected by the space under the protruding bridge portion 1830a. The embedded portion 1862 fills up the middle hole 1822b, the side hole 1822c, and the connection space. In the embodiment, the cantilever plate 184 is closer to the hook portion 1864, and the protruding bridge portion 1830a is closer to the rear side of the joining portion 186 and the rib 1868. If needed, it is alternatively practicable that the cantilever plate 184 can be closer to the rear side of the joining portion 186 and the rib 1868 while the protruding bridge portion 1830a is closer to the hook portion 1864. Similarly, the height h4 for the protruding bridge portion 1830a is not higher than a half of the slot height h3 of the sliding slot 18c.

Furthermore, regardless of whether the wing portions 1866, 1876 and 1884 in the above embodiments, are attached to the bottom surfaces 1824 and 1825 or the upper surfaces 1826 and 1827, the larger the area of the wing portions 1866, 1876 and 1884 is, the better the wing portions 1866, 1876 and 1884 can resist an upward external force to a certain extent and prevent the joining portion 186 from separating from the bottom plate portions 182 and 183a. However, the outer size of oversized wing portions 1866, 1876 and 1884 will limit the configuration of other components or backlight effect in the keyswitch structure 1. The design of the wing portions 1866, 1876 and 1884 needs to consider the overall functional performance of the keyswitch structure 1 and avoid interference with surrounding components.

Although the keyswitch support connection structures 180a, 180a′ and 180b of the above embodiments focus on resisting pulling external forces, modern automated assembly processes may adopt assembly that involves interference with the above various joining portions 186, 187 and 188 (e.g. the hook portions 1864, 1872, 1881a and 1881b) during the installation of the first keyswitch support and/or the second keyswitch support 16. The coordinating configurations of the protruding bridge portions 1830 and 1830a, the ribs 1868 and 1878, the bottom surface of the hook portion 1872, the wing portions 1866, 1876 and 1884, and the cantilever plates 184, 184′, 184″, 185 and 185a of the above embodiments also help to enhance the structural resistance of the keyswitch support connection structures 180a, 180a′ and 180b when assembling the first keyswitch support 14 and/or the second keyswitch support 16 the keyswitch support connection structures 180a, 180a′ and 180b.

In addition, both the cantilever plates 184, 184′, 184″, 185 and 185a or the protruding bridge portions 1830 and 1830a are extended micro structures mechanically processed from the bottom plate portions 182, 182′, 182″, 183 and 183a. The higher or longer such extended micro structures are processed, the more shear stress has been applied thereto, which means the cantilever plates 184, 184′, 184″, 185 and 185a or the protruding bridge portions 1830 and 1830a could be too weak to support the joining portions 186, 187 and 188 from deformation or separation by external pulling forces.

Therefore, it would be better if the height of the middle line for each of the protruding bridge portions 1830 and 1830a is not higher than 50% or 75% of the total height of the joining portions 186, 187 and 188. Each of the protruding bridge portions 1830 and 1830a provides sufficient pulling strength when, the height of its middle line is proximate to or even lower than the middle line of the total height of the joining portions 186, 187 and 188, or proximate to or lower than the middle line of the sliding slot 18c or the shaft recess 1886.

Similarly, it would be better if the height of the middle line for each of the holding structures 1842, 1842a, 1842b and 1852 of the cantilever plates 184, 184′, 184″, 185 and 185a is not higher than 50% or 75% of the total height of the joining portions 186, 187 and 188. Each of the holding structures 1842, 1842a, 1842b and 1852 of the cantilever plates 184, 184′, 184″, 185 and 185a provides sufficient pulling strength when, the height of its middle line is proximate to or lower than the middle line of the total height of the joining portions 186, 187 and 188, or proximate to or lower than the middle line of the sliding slot 18c or the shaft recess 1886.

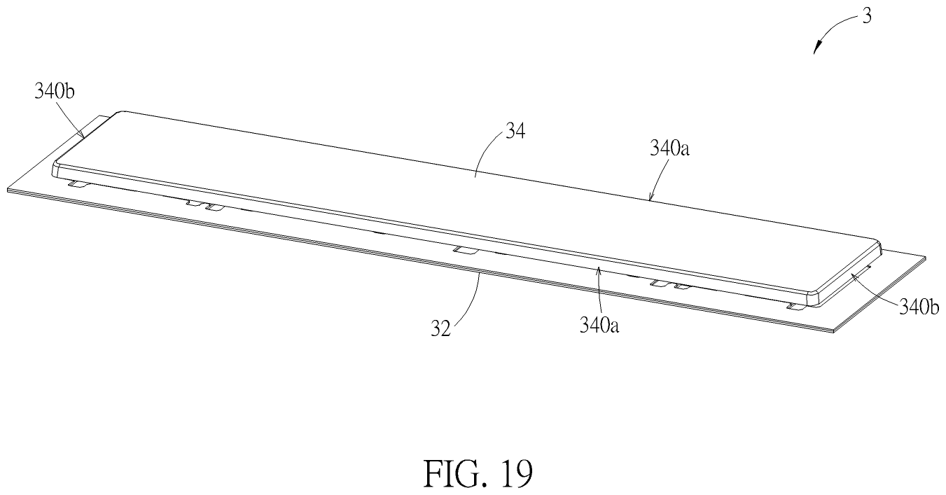

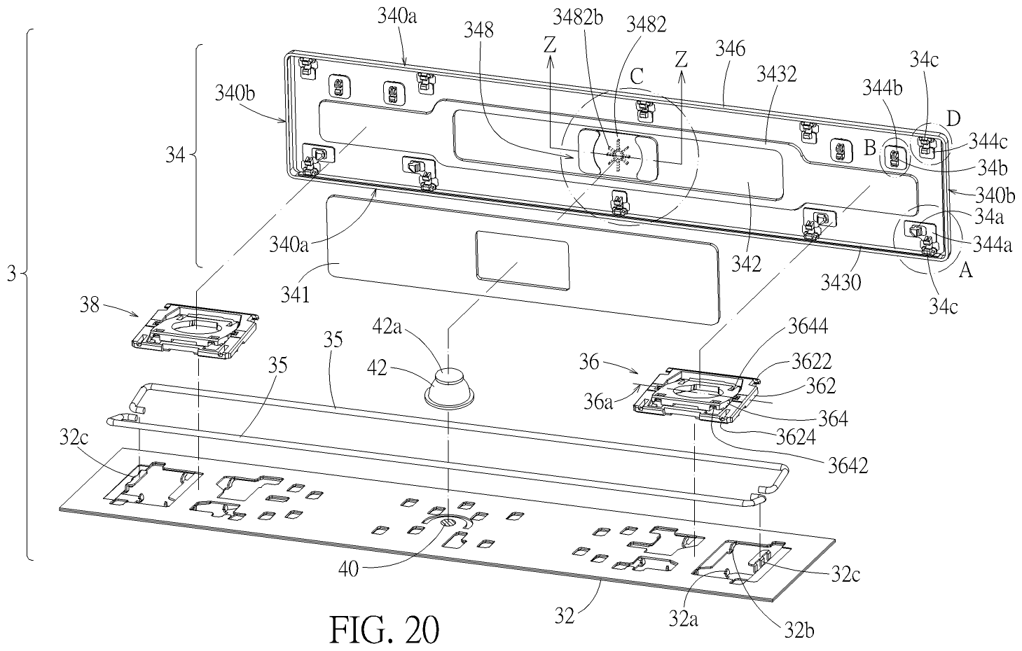

Please refer to FIG. 19 and FIG. 20. A keyswitch structure 3 according to a ninth embodiment includes a base 32, a keycap 34, a first lifting mechanism 36, a second lifting mechanism 38, a switch 40, and an elastic restoring part 42. The keycap 34 is disposed above the base 32 and has four side edges 340a and 340b, forming a long and narrow rectangle with two long sides and two short sides. The first lifting mechanism 36 and the second lifting mechanism 38 are connected to and between the keycap 34 and the base 32, so that the keycap 34 is vertically movable (or up and down movable) relative to the base 32 through the first lifting mechanism 36 and the second lifting mechanism 38. The switch 40 (shown by a hatched circle in the figure; for example, which is achieved by, but not limited to a membrane circuit board, on which switch circuitry is formed) is disposed under the keycap 34. The elastic restoring part 42 (such as but not limited to a rubber dome) is disposed between the base 32 and the keycap 34 corresponding to the switch 40. The keycap 34 can be pressed down to squeeze the elastic restoring part 42 downward to trigger the switch 40.

In the ninth embodiment, the first lifting mechanism 36 includes a first keyswitch support 362 and a second keyswitch support 364, which are connected to and between the keycap 34 and the base 32 and are pivotally connected with each other along a rotation axis 36a (indicated by a chain line in FIG. 20). The first lifting mechanism itself is symmetrical (in the view point of FIG. 20). For simplification of the description, the following description is based on the structure on one side of the first lifting mechanism 36 for example. In the first lifting mechanism 36, the first keyswitch support 362 has a first keycap connection portion 3622 and a first base connection portion 3624. The second keyswitch support 364 has a second keycap connection portion 3642 and a second base connection portion 3644; correspondingly, the base 32 has two support connection portions 32a and 32b. The keycap 34 has two support connection portions 34a and 34b. The first keyswitch support 362 is connected to the support connection portion 34a of the keycap 34 and the support connection portion 32a of the base 32 through the first keycap connection portion 3622 and the first base connection portion 3624 respectively. The second keyswitch support 364 is connected to the support connection portion 34b of the keycap 34 and the support connection portion 32b of the base 32 through the second keycap connection portion 3642 and the second base connection portion 3644 respectively. In addition, in the ninth embodiment, the second lifting mechanism 38 and the first lifting mechanism 36 have the same structure. For the relevant descriptions of the second lifting mechanism 38 (including the relevant descriptions of the structure corresponding to base 32 and keycap 34), please refer to the relevant descriptions of the first lifting mechanism 36, which will not be repeated. Furthermore, in the ninth embodiment, the keycap 34 also includes a plurality of balance bracket connection portions 34c. Two balance brackets 35 are connected to the keycap 34 through the plurality of balance bracket connection portions 34c and are connected to the base 32 through a plurality of balance bracket connection portions 32c of the base 32. Therein, the portions of the balance bracket 35 held by the plurality of balance bracket connection portions 34c extend along the length direction of the keycap 34. This structural configuration can improve the movement stability of the keycap 34, and increase the rigidity of the overall structure of the keycap 34.

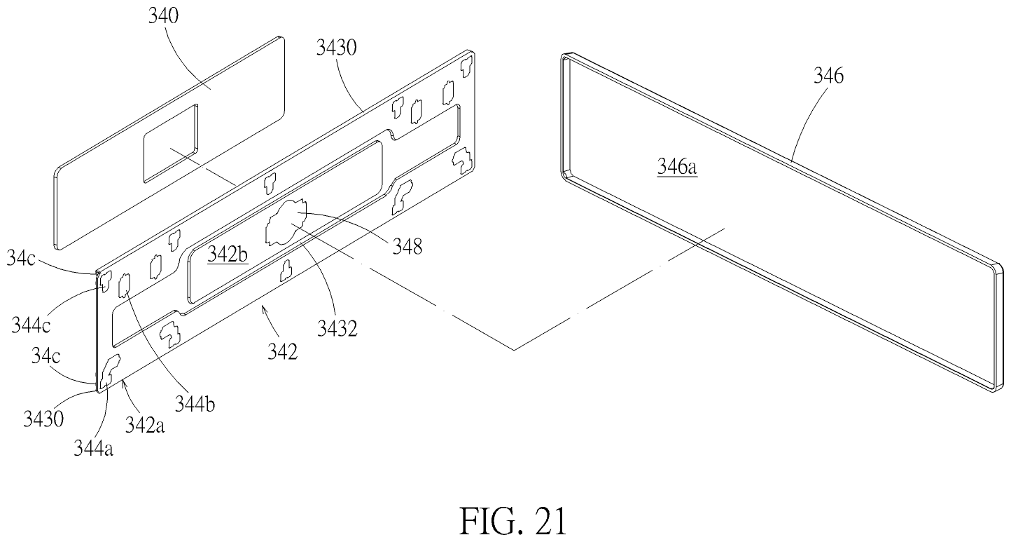

Please also refer to FIG. 21. The keycap 34 includes a structural plate 342, two joining portions 344a and 344b, and a keycap cover 346. The joining portions 344a and 344b are individually joined with the structural plate 342, so that the structural plate 342 and the joining portion 344a or 344b jointly form or the joining portion 344a or 344b alone forms a support connection portion 34a and 34b. The keycap cover 346 is fixed onto the structural plate 342. The keycap cover 346 and the support connection portions 34a and 34b are located at the upper and lower sides of the structural plate 342. A user can touch the keycap cover 346 to press the keycap 34. In practice, the structural plate 342 and the keycap cover 346 may be made of different materials, which can increase the structural design flexibility of the overall keycap 34 and help to take account of the rigidity and thin design of the overall structure of the keycap 34. For example, but not limited to, the structural plate 342 is a metal stamping part, and the keycap cover 346 is a plastic injection molded part; the latter is conducive to the appearance and touch design of the keycap 34. Furthermore, in practice, the joining portions 344a and 344b may be made of plastic, resin, or other polymer materials, and formed by but not limited to by injection molding. For example, the joining portions 344a and 344b are formed and joined with the structural plate 342 by insert molding. In addition, in structural logic, the combination of the structural plate 142 and the joining portion 344a is equivalent to a keyswitch support connection structure (structurally integrated into the keycap 34, for the first keyswitch support 362 to be connected to the keycap 34) ; the combination of the structural plate 342 and the joining portion 344b is equivalent to another keyswitch support connection structure (structurally integrated into keycap 34, for the second keyswitch support 364 to connect to keycap 34).

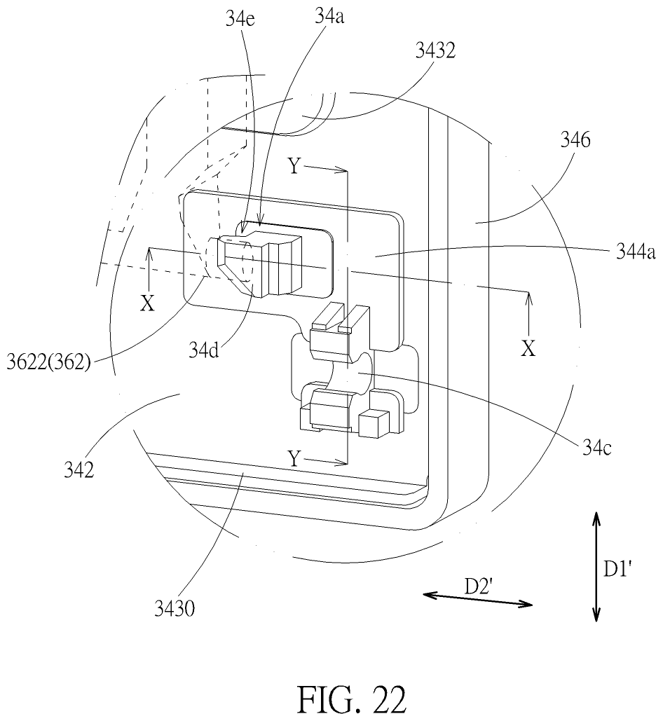

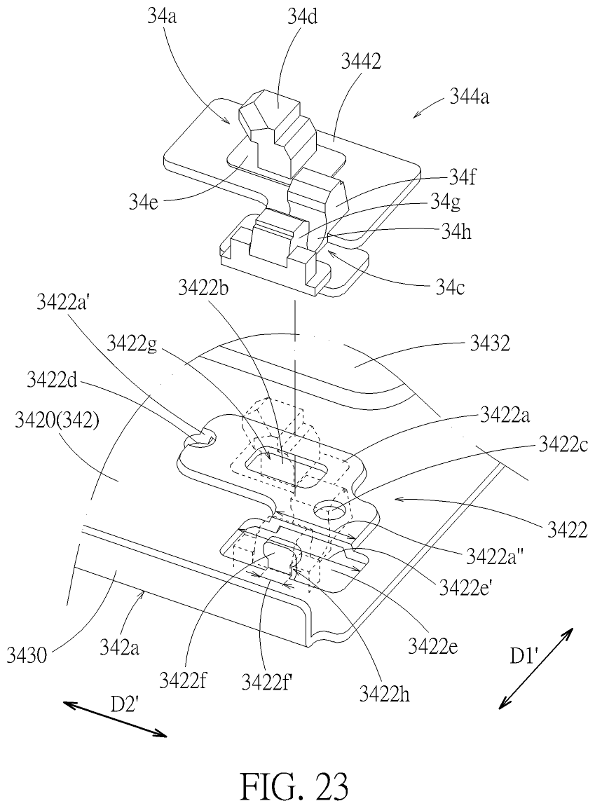

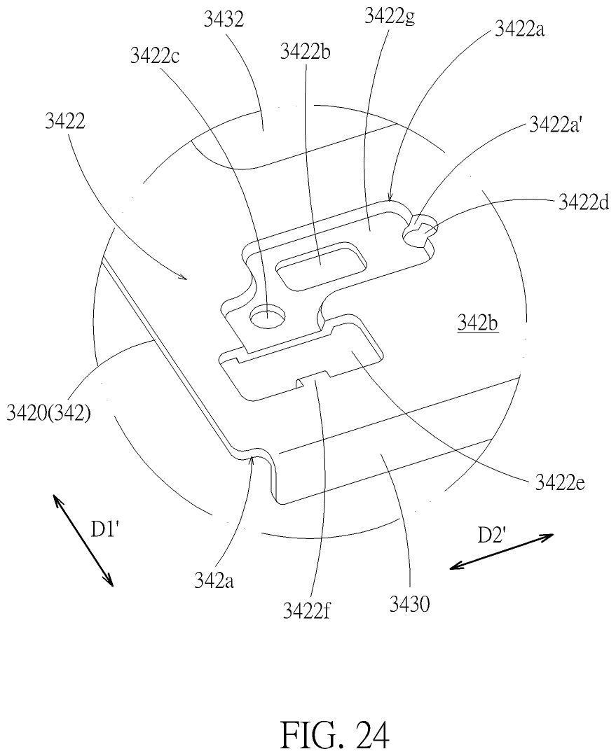

Please also refer to FIG. 22 to FIG. 26. In the ninth embodiment, the structural plate 342 has a joining structure 3422. The joining portion 344a is firmly engaged with the joining structure 3422 to be combined with the structural plate 342. The joining structure 3422 includes a protruding portion 3422a, two through holes 3422b and 3422c, aside hole 3422d, a joining hole 3422e, and a cantilever plate 3422f. The protruding portion 3422a protrudes from a side of the structural plate 342 (such as the upward side in FIGS. 22, 23, 25 and 26) and forms a recess 3422g at the other side of the structural plate 342 (such as the downward side in FIGS. 22, 23, 25 and 26). That is, in FIGS. 22, 23, 25 and 26, the protruding portion 3422a protrudes from the structural plate 342 upward, and the opening of the recess 3422g faces below the structural plate 342. The through holes 3422b and 3422c and the side hole 3422d all pass through the protruding portion 3422a. Therein, the through holes 3422b and 3422c pass through the top surface (i.e. the portion where the lead line labelled with “3422a” in FIG. 23) of the protruding portion 3422a (that is, the through holes 3422b and 3422c is formed on the top surface of the protruding portion 3422). The side hole 3422d passes through a side wall 3422a′ of the protruding portion 3422a, a portion of the top surface of the protruding portion 3422a, and a portion of the structural plate 342 (that is, the side hole 3422d is partially formed on the top surface of the protruding portion 3422a, partially formed on the side wall 3422a′, and partially formed on the body of the structural plate 342). The joining hole 3422e is disposed adjacent to the protruding portion 3422a and communicates with the recess 3422g. The cantilever plate 3422f bends and extends from an edge of the joining hole 3422e (i.e. upward bending and extending in FIGS. 22, 23 and 26). The joining hole 3422e is located between the protruding portion 3422a and the cantilever plate 3422f. The joining portion 344a fills the through holes 3422b and 3422c, the side hole 3422d, the joining hole 3422e, and the recess 3422g, and encapsulates the protruding portion 3422a and the cantilever plate 3422f. In the view point of FIGS. 22, 23, 25 and 26, the joining portion 144a is simultaneously formed on the upper and lower sides of the protruding portion 3422a (or formed on the upper and lower sides of the structural plate 342 in structural logic). The through holes 3422b and 3422c, the side hole 3422d, and the joining hole 3422e are conducive to the formation of the joining portion 344a (for example, which can increase the efficiency of filling the mold during injection of plastic so as to avoid short shot) and also help the joining portion 344a to encapsulate the protruding portion 3422a (so as to increase the bonding strength between the two). Therein, the through holes 3422b and 3422c and the side hole 3422d are conducive to the increase of the cross-sectional area of the joining portion 344a passing through the protruding portion 3422a. The upper wing sheet 3442 of the joining portion 344a (above the protruding portion 3422a) and the lower wing sheet 3444 of the joining portion 344a (below the protruding portion 3422a, or inside the recess 3422g) can increase the area of mutual connection through the through holes 3422b and 3422c, the side hole 3422d, and the joining hole 3422e (therein, penetrating through the side hole 3422d of the side wall 3422a′ can provide a larger structural connection cross-section for the upper wing sheet 3442 and the lower wing sheet 3444 than penetrating through the through hole 3422c on the top surface of the protruding portion 3422a), which enhances the holding effect of the upper wing sheet 3442 and the lower wing sheet 3444 on the protruding portion 3422a, which is conducive to the bonding strength between the joining portion 344a and the structural plate 342 (or the protruding portion 3422a) and also increases the structural stability and tensile strength of the support connection portion 34a.

In the ninth embodiment, the joint portion 344a independently forms the support connection portion 34a and the balance bracket connection portion 34c. The joining portion 344a includes a first hook arm 34d corresponding to the support connection portion 34a. The first hook arm 34d is formed on the protruding portion 3422a, for forming the support connection portion 34a. The first hook arm 34d is L-shaped and forms a sliding slot 34e. The first keyswitch support 362 is slidably disposed in the sliding slot 34e through the first keycap connection portion 3622 (of which part of the profile is shown in dashed lines in FIG. 4) so as to slidably connect with the support connection portion 34a. The through hole 3422b is aligned with the support connection portion 34a ; in other words, the projections of the through hole 3422b and the support connection portion 34a in the vertical direction overlap. From another aspect, the vertical projection of the first hook arm 34d is located within the top surface of the protruding portion 3422a (therein, the profile of the first hook arm 34d on the protruding portion 3422a is shown in dashed lines in FIG. 23). This structural configuration helps to increase the structural bonding strength between the joining portion 344a (especially the support connection portion 34a) and the protruding portion 3422a, so as to increase the structural stability and tensile strength of the support connection portion 34a (such as the ability to resist the first keyswitch support 362 pulling up the first hook arm 34d in the view point of FIG. 22 and FIG. 23). Therein, the projections of the first hook arm 34d and the through hole 3422b in the vertical direction overlap, and the through hole 3422c and the side hole 3422d are located at front and rear sides of the support connection portion 34a. The above two features are conducive to enhancement of the tensile strength of the support connection portion 34a (or the first hook arm 34d). Furthermore, in the ninth embodiment, the joining portion 344a independently forms the support connection portion 34a, but it is practicable to form the support connection portion 34a jointly by the joining portion 344a and the protruding portion 3422a in practice. For example, the top surface of the protruding portion 3422a can be used as the bottom of the sliding slot 34e.

Furthermore, the joining portion 344a also includes a first holding arm 34f and a second holding arm 34g corresponding to the balance bracket connection portion 34c. The first holding arm 34f is formed on the protruding portion 3422a. The second holding arm 34g encapsulates the cantilever plate 3422f. The first holding arm 34f and the second holding arm 34g are used for forming the balance bracket connection portion 34c. The opposite inner concave walls of the first holding arm 34f and the second holding arm 34g jointly define a shaft recess 34h for the balance bracket 35 to pass through. The projections of the first holding arm 34f and the second holding arm 34g (of the balance bracket connection portion 34c) in the vertical direction overlap the through hole 3422c and the cantilever plate 3422g respectively (therein, the profiles of the first holding arm 34f and the second holding arm 34g on the protruding portion 3422a and the cantilever plate 3422f are shown in dashed lines in FIG. 23), which can effectively increases the tensile strength of the balance bracket connection portion 34c (or, the first holding arm 34f and the second holding arm 34g) , such as the ability to resist the balance bracket 35 pulling up the first holding arm 34f and the second holding arm 34g in the view point of FIG. 22 and FIG. 23). This structural configuration is conducive to the bonding strength between the balance bracket connection portion 34c and the joining structure 3422 and also increases the structural stability and tensile strength of the balance bracket connection portion 34c. Furthermore, in the viewpoint of FIG. 22 and FIG. 23, the bottom of the holding space (i.e. the shaft recess 34h) of the balance bracket connection portion 14c to the balance bracket 35 is slightly higher than the structural plate 342. The structural plate 342 makes relief space through the joining hole 3422e to increase the structural strength of the balance bracket connection portion 34c. The joining hole 3422e communicates with the recess 3422g, which is conducive to the bonding strength between the balance bracket connection portion 34c and the protruding portion 3422a. Therein, as shown by FIG. 22, the protruding portion 3422a, the joining hole 3422e, and the cantilever plate 3422f are arranged along a first direction D1′ (indicated by a double-headed arrow in the figures). The width 3422e′ (or hole diameter) of the joining hole 3422e in a second direction D2′ (indicated by a double-headed arrow in the figures, perpendicular to the first direction D1′) is larger than the width 3422a″ of the protruding portion 3422a (adjacent to the joining hole 3422e) in the second direction D2′ and larger than the width 3422f′ of the cantilever plate 3422f in the second direction D2′. The portion of the joining hole 3422e adjacent to the protruding portion 3422a has a relatively large size, which is conducive to the application of millimeter-level precision machining and precision plastic processing. When machining the structural plate 342, the larger joining hole 3422e facilitates cutting the cantilever plate 3422f and through hole 3422c of specific shape and position, and the larger joining hole 3422e also facilitates forming the protruding portion 3422a of specific size/shape opposite to the cantilever plate 3422f. During injection molding, the plastic can fill up the recess 3422g under the protruding portion 3422a, which can avoid short shot. In practice, the wider the cantilever plate 3422f is, the greater the pull-out resistance will increase; however, it will not be easy for the plastic to fill up to encapsulate the balance bracket connection portion 34c of the cantilever plate 3422f, and will make the structure of the balance bracket connection portion 34c too large and occupy a large space.

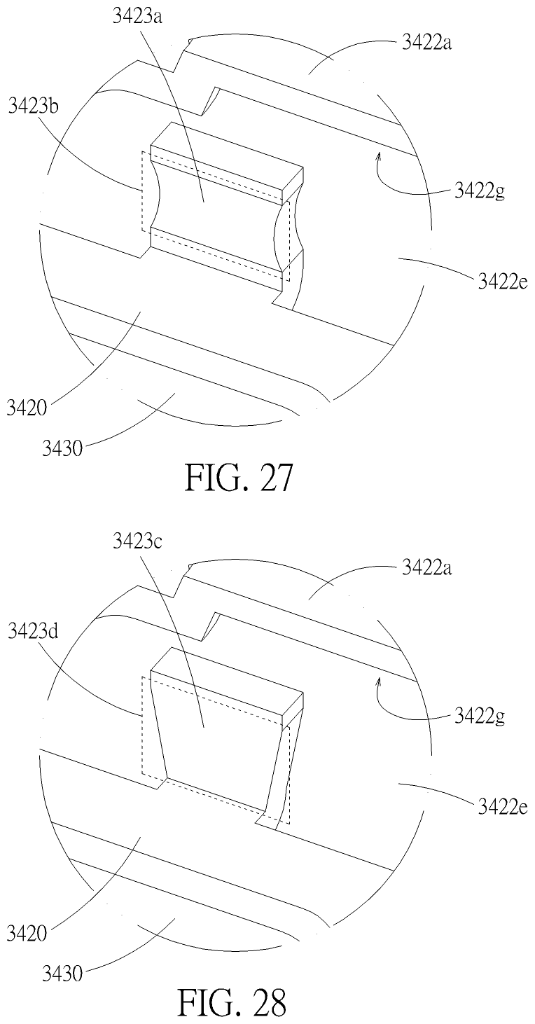

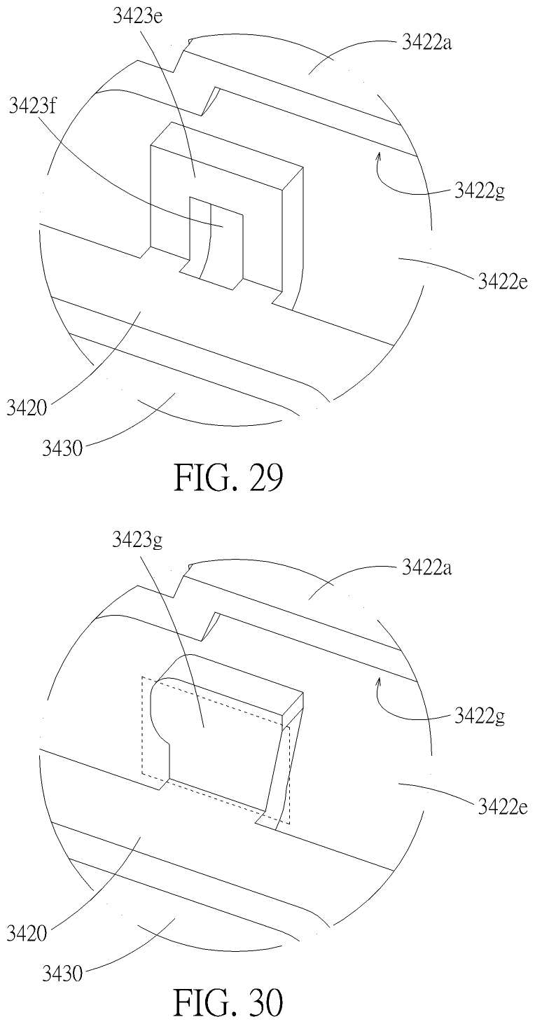

In the ninth embodiment, the cantilever plate 3422f has a holding structure 3422h, which can increase the bonding strength between the joining portion 344a (or the balance bracket connection portion 34c) and the cantilever plate 3422f (or the ability of the joining portion 344a to resist separating from the cantilever plate 3422f). In the ninth embodiment, the holding structure 3422h is a necking portion of the cantilever plate 3422f between the fixed and free ends of the cantilever plate 3422f. The necking portion can increase the contact area between the joining portion 344a and the cantilever plate 3422f and the degree of structural interference with the joining portion 344a. The cantilever plate 3422f as a whole shows a T-shaped structure and uses the width difference between the head and the body as the structural basis of the necking portion, but it is not limited thereto in practice. For example, the cantilever plate 3422f can be replaced by a cantilever plate 3423a with a substantially fixed width, as shown by FIG. 27. Therein, a notch is formed between the fixed and free end of the cantilever plate 3423a, which can also be used as the necking portion 3423b (shown in dashed lines in the figure). For another example, the cantilever plate 3422f can be replaced by a cantilever plate 3423c with a gradually changing width, as shown by FIG. 28. Therein, the width of the cantilever plate 3423a gradually increases from the fixed end to the free end. The two side edges of the cantilever plate 3423c can serve as a necking portion 3423d (shown in dashed lines in the figure) in logic. Furthermore, the holding structure 3422h may be achieved by other structures in practice, for example, by a through hole 3423f (or a blind hole) on the cantilever plate 3423e (or a zigzag structure formed on the two side edges of the cantilever plate 3423e), as shown by FIG. 29. For another example, a holding structure 3422h may be achieved by a combination of the above structure, e.g. a cantilever plate 3423g in FIG. 30, of which the holding structure (indicated by a dashed frame in the figure) includes a necking portion at a side of the cantilever plate 3423g and a slant edge at another side of the cantilever plate 3423g (or the side edge of the cantilever plate 3423g that gradually varies in width). The cantilever plates 3423a, 3423c, 3423e and 3423g of the aforementioned variations can all increase the bonding strength with the joining portion 344a by interfering with the structure of the joining portion 344a.

In addition, in the ninth embodiment, the cantilever plate 3422f itself is a flat structure, that is, bending once and extending upward from the plate body 3420 of the structural plate 342. When the second holding arm 34g pulls the cantilever plate 3422f upward, the cantilever plate 3422f itself will in principle only bear axial stress (that is, stress parallel to the extension direction) without bending stress. Besides, the upward pulling force of the second holding arm 34g to the cantilever plate 3422f produces a small moment on the fixed end of the cantilever plate 3422f (that is, where the plate body 3420 is bent), so the fixed end of the cantilever plate 3422f bears less bending stress. This structural feature enables the cantilever plate 3422f to produce smaller deformations when subjected to the upward pulling force, which helps to maintain the structural stability of the cantilever plate 3422f itself and the joining portion 344a (or the balance bracket connection portion 34c).

Furthermore, as shown by FIG. 22 and FIG. 23, in the ninth embodiment, the balance bracket connection portion 34c is close to the support connection portion 34a, so the two structures are integrally formed by a single joining portion 344a. Therein, the structural plate 342 (or the plate body 3420 thereof) has a side edge 342a. The balance bracket connection portion 34c is located between the support connection portion 34a and the side edge 342a. The joining structure 3422 is close to the side edge 342a. The space of the structural plate 342 for disposing the joining structure 3422 is limited. The cantilever plate 3422f is located between the protruding portion 3422a and the side edge 342a, which can take account of the combination of structure and the space utilization. In practice, if space permits, the balance bracket connection portion 34c and the support connection portion 34a can also be separated in structure and formed separately. In addition, if structural space permits, the structure of the joining structure 3422 corresponding to the balance bracket connection portion 34c (including part of the protruding portion 3422a, the through hole 3422c, the joining hole 3422e, and the cantilever plate 3422f) can also be applied to the structure of the joining structure 3422 corresponding to the support connection portion 34a, and vice versa.

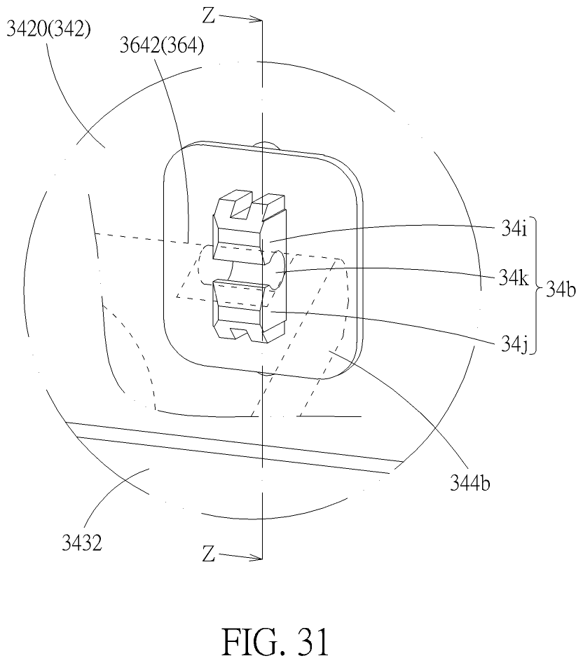

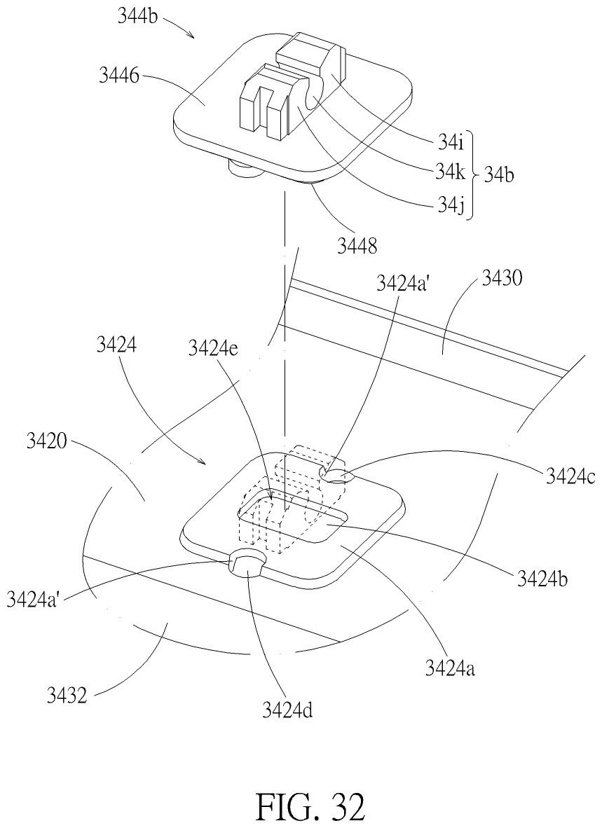

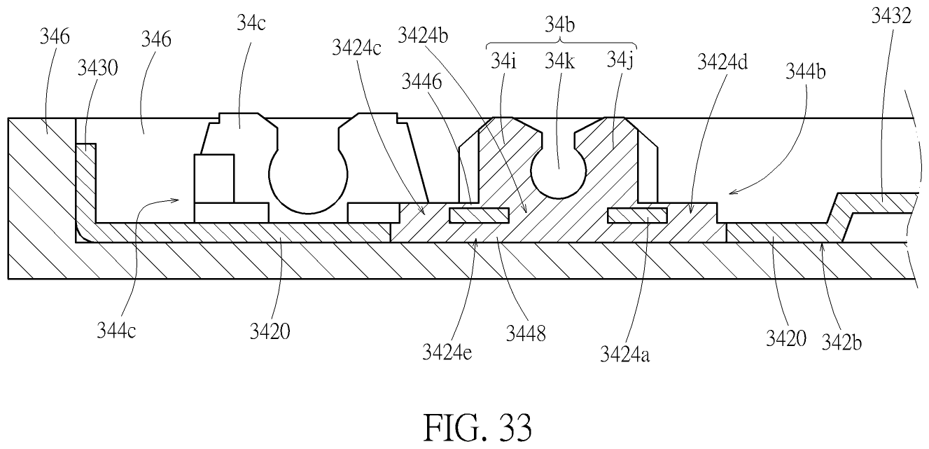

Please refer to FIGS. 20, 21, and 31 to 33. In the ninth embodiment, the structural plate 342 has another joining structure 3424, corresponding to the support connection portion 34b. The joining structure 3424 includes a protruding portion 3424a, a through hole 3424b, and two side holes 3424c and 3424d. The protruding portion 3424a is located at a side of the structural plate 342 (i.e. the upward side in FIG. 31 to FIG. 33) and a recess 3424e is formed at another side of the structural plate 342 (i.e. the downward side in FIG. 31 to FIG. 33). That is, in FIG. 31 to FIG. 33, the protruding portion 3424a protrudes from the structural plate 342 upward, and the opening of the recess 3424e faces below the structural plate 342. The through hole 3424b and the side holes 3424c and 3424d all pass through the protruding portion 3424a. Therein, the through hole 3424b passes through the top surface (i.e. the portion where the lead line labelled with “3424a” in FIG. 32) of the protruding portion 3424a (that is, the through hole 3424b is formed on the top surface of the protruding portion 3424). The side holes 3424c and 3424d pass through two opposite side walls 3424a′ of the protruding portion 3424a, a portion of the top surface of the protruding portion 3424a, and a portion of the structural plate 342 (that is, the side holes 3424c and 3424d is partially formed on the top surface of the protruding portion 3424a, partially formed on the side walls 3424a′, and partially formed on the body of the structural plate 342). The through hole 3424b is located between the two side holes 3424c and 3424d. The joining portion 344b fills the through hole 3424b, the side holes 3424c and 3424d, and the recess 3424e, and encapsulates the protruding portion 3424a. In the view point of FIG. 31 to FIG. 33, the joining portion 344b is simultaneously formed on the upper and lower sides of the protruding portion 3424a (or formed on the upper and lower sides of the structural plate 342 in structural logic). The through hole 3424b and the side holes 3424c and 3424d are conducive to the formation of the joining portion 344b (for example, which can increase the efficiency of filling the mold during injection of plastic so as to avoid short shot) and also help the joining portion 344b to encapsulate the protruding portion 3424a (so as to increase the bonding strength between the two). Therein, the through hole 3424b and the side holes 3424c and 3424d are conducive to the increase of the cross-sectional area of the joining portion 344b passing through the protruding portion 3424a. The upper wing sheet 3446 of the joining portion 344b (above the protruding portion 3424a) and the lower wing sheet 3448 of the joining portion 344b (below the protruding portion 3424a, or inside the recess 3424e) can increase the area of mutual connection through the through hole 3424b and the side holes 3424c and 3424d, which enhances the holding effect of the upper wing sheet 3446 and the lower wing sheet 3448 on the protruding portion 3424a, which is conducive to the bonding strength between the joining portion 344b and the structural plate 342 (or the protruding portion 3424a) and also increases the structural stability and tensile strength of the support connection portion 34b.

In the ninth embodiment, the joint portion 344b independently forms the support connection portion 34b. The joining portion 344b includes a first hook arm 34i and a second hook arm 34j. The first hook arm 34i and the second hook arm 34j are formed on the top surface of the protruding portion 3424a opposite to each other, for forming the support connection portion 34b. The opposite inner concave walls of the first holding arm 34i and the second holding arm 34j jointly define a shaft recess 34k. The second keyswitch support 364 is rotatably disposed in the shaft recess 34k through the second keycap connection portion 3642 (of which part of the profile is shown in the dashed lines in FIG. 31) to be rotatably connected to the support connection portion 34b. The through hole 1424b is aligned with the support connection portion 34b ; in other words, the projections of the through hole 3424b and the support connection portion 34b in the vertical direction overlap. From another aspect, the vertical projections of the first hook arm 34i and the second hook arm 34j are located within the top surface of the protruding portion 3424a (therein, the profiles of the first hook arm 34i and the second hook arm 34j on the protruding portion 3424a are shown in dashed lines in FIG. 32). This structural configuration helps to increase the structural bonding strength between the joining portion 344a (especially the support connection portion 34b) and the protruding portion 3424a, so as to increase the structural stability and tensile strength of the support connection portion 34b (such as the ability to resist the second keyswitch support 364 pulling up the first hook arm 34i and the second hook arm 34j in the view point of FIG. 31 and FIG. 32). Therein, the projections of the first hook arm 34i and the second hook arm 34j in the vertical direction overlap the profiles of the side holes 3424c and 3424d respectively, which is conducive to enhancement of the tensile strength of the support connection portion 34b (or the first hook arm 34i and the second hook arm 34j). Furthermore, in the ninth embodiment, the joining portion 344b independently forms the shaft recess 34k of the support connection portion 34b, but it is practicable to form the support connection portion 34b jointly by the joining portion 344b and the protruding portion 3424a in practice. For example, the top surface of the protruding portion 3424a can be used as the bottom of the shaft recess 34k.

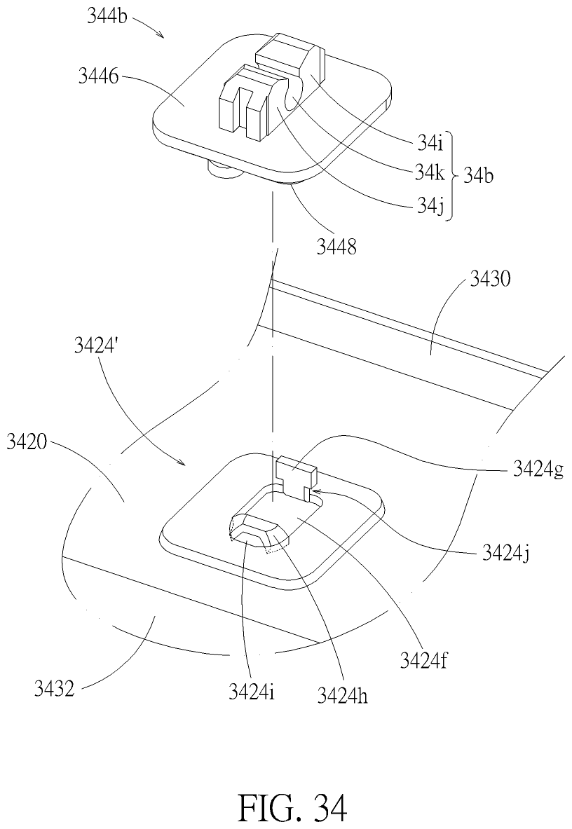

In the ninth embodiment, a part of the joining structure 3422 that is used for joining the corresponding support connection portion 34a (including the first hook arm 34d) and the balance bracket connection portion 34c, and a part of the joining structure 3424 that is used for joining the corresponding support connection portion 34b are not the same, but it is not limited thereto in practice. In addition, the joining structures of the structural plate 342 with the support connection portions 34a and 34b and the balance bracket connection portion 34c are not limited to the above embodiments. For example, as shown by FIG. 34, in a second embodiment, a joining structure 3424′ corresponding to the support connection portion 34b includes a through hole 3424f, a cantilever plate 3424g, and a protruding bridge portion 3424h in addition to the protruding portion 3424a. The through hole 3424f, the protruding bridge portion 3424h, and the cantilever plate 3424g are all located on the top surface of the protruding portion 3424a. The cantilever plate 3424g bends and extends from an edge of the through hole 3424f. The protruding bridge portion 3424h is connected across and to two sides of the through hole 3424f relative to the cantilever plate 3424g (that is, dividing the projection of through hole 3424f in the vertical direction into two portions, or dividing the through hole 3424f to form a side hole portion 3424i, in which the side hole portion 3424i and the cantilever plate 3424g are located at two sides of the protruding bridge portion 3424h ; from another aspect, in structural logic, the through hole 3424f can be regarded as located between the protruding bridge portion 3424h and the cantilever plate 3424g). The joining portion 344b fills up the through hole 3424f and the recess 3424e and encapsulates the cantilever plate 3424g and the protruding bridge portion 3424h (therein, the first hook arm 34i and the second hook arm 34j encapsulate the cantilever plate 3424g and the protruding bridge portion 3424h respectively, for forming the support connection portion 34b). This structural configuration helps to increase the bonding strength between the first and second hook arms 34i and 34j and the joining structure 3424′, so as to enhance the structural stability of the support connection portion 34b.

Furthermore, in the tenth embodiment, the cantilever plate 3424g is similar in structure to the cantilever plate 3422f of the joining structure 3422 in the ninth embodiment, and also has a holding structure 3424j, which increases the bonding strength between the corresponding first hook arm 34i and the cantilever plate 3424g. For other descriptions about the holding structure 3424j, please refer to the relevant descriptions of the cantilever plate 3422f and variants thereof, which will not be repeated in addition. Furthermore, in the tenth embodiment, the connection interface (shown in dashed lines in FIG. 34) of the protruding bridge portion 3424h and the joining hole 3424f is curved, which can increase the moment of inertia of the protruding bridge portion 3424h and increase the ability of the protruding bridge portion 3424h to resist being pulled by the support connection portion 34b. In addition, in the tenth embodiment, the joining structure 3424′ is not limited to be provided with the cantilever plate 3424g and the protruding bridge portion 3424h at the same time. For example, in the joining structure 3424′, the cantilever plate 3424g is replaced with a protruding bridge portion, or the protruding bridge portion 3424h is replaced with a cantilever plate. For another example, in the joining structure 3424′, only one of the cantilever plate 3424g and the protruding bridge portion 1424h remains, and it is practicable to add a structure like the through holes 3424c and 3424d in the joining structure 3424.

In addition, according to the descriptions of the structures of the joining structures 3422, 3424 and 3424′ that are used for joining the corresponding support connection portion 34a (including the first hook arm 34d) , the support connection portion 34b (including the first and second hook arms 34i and 34j), and the balance bracket connection portion 34c (including the first and second holding arms 34f and 34g), the combination of the structural plate 342 and the support connection portions 34a, 34b and the balance bracket connection portion 34c can be achieved by use of the structural features of the protruding portion, the cantilever plate, the joining hole, the through hole, or the combinations thereof, which will not be described in addition. For example, in the ninth embodiment, as shown by FIG. 23, the joining structure 3422 may include a cantilever plate at an edge of the through hole 3422b. The support connection portion 34a encapsulates this cantilever plate. This structural configuration can increase the structural stability of the support connection portion 34a.

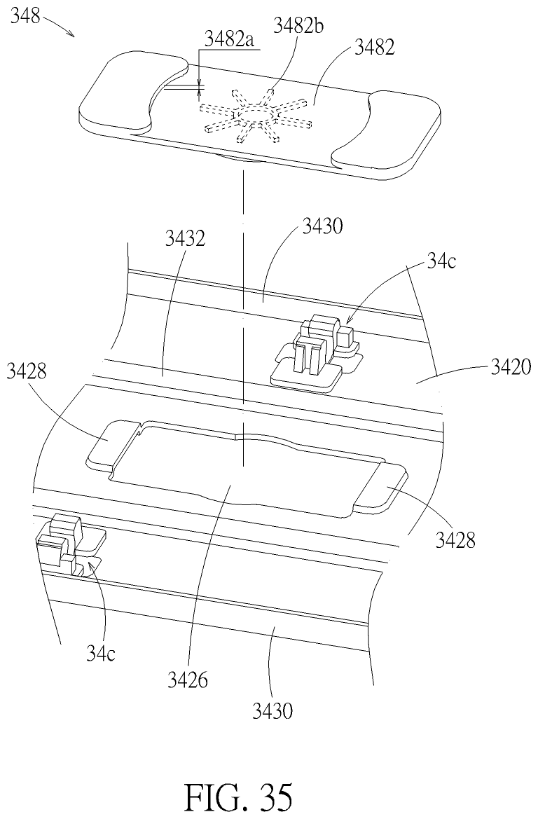

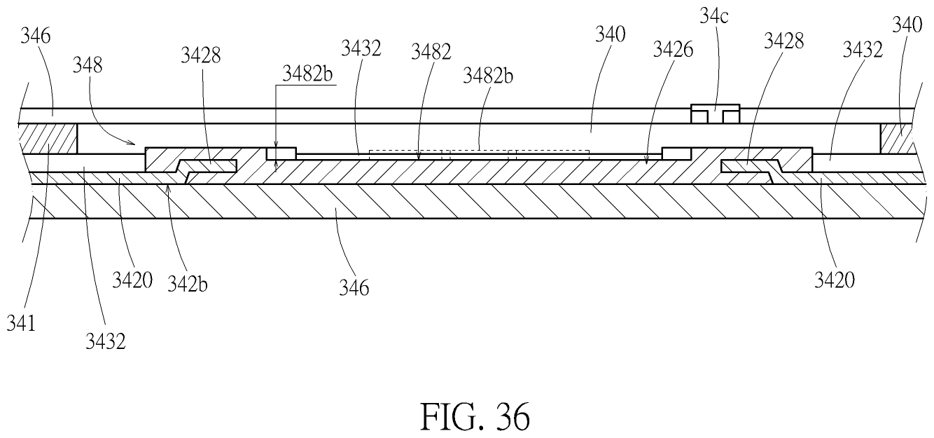

Please refer to FIGS. 20, 21, 35 and 36. In the tenth embodiment, the keycap 34 includes a press portion 348, corresponding to the elastic restoring part 42 (of which a part of the profile is shown in dashed lines in FIG. 36). The structural plate 342 includes a second joining hole 3426 and two second protruding portions 3428. The two second protruding portions 3428 protrude from two opposite side edges of the second joining hole 3426 respectively. The press portion 348 fills up the second joining hole 3426 and encapsulates the two second protruding portions 3428, so as to be fixed on the structural plate 342. In practice, the press portion 348 maybe fixed to the structural plate 342 through other joining structures, which will be described in addition. The press portion 148 has a pre-press portion 3482, which faces the elastic restoring part 42 and provides a preset pressure to the elastic restoring part 42 (that is, by the pre-press portion 3482 abutting against the top portion 42a of the elastic restoring part 42). When being pressed, the keycap 34 squeezes the elastic restoring part 42 through the pre-press portion 3482. In the ninth embodiment, the pre-press portion 3482 is the bottom of a recess. The depth 1482a of the pre-press portion 3482 (i.e. the depth of the recess) can be determined according to product specifications (such as the requirement of pressing feedback force) or product manufacturing requirements (such as the difference in the mechanical characteristics of the elastic restoring part 42 of different batches), for example, so that the elastic deformation of the elastic restoring part 42 can be controlled for providing the user with a desired pressing tactile feeling. In practice, the press portion 348 can be fixed on the structural plate 342 by but not limited to insert molding, which helps to adjust the depth 3482a of the pre-press portion 3482 at a lower modification cost, without modifying the entire keycap 34 structure. Furthermore, the projection of the top portion 22a of the elastic restoring part 22 in the vertical direction is located within the projection of the second joining hole 3426 in the vertical direction, so the second joining hole 3426 has the function of structural interference avoidance, so that the pre-press portion 3482 is located within the second joining hole 3426, which can increase the adjustment range of the depth 3482a of the pre-press portion 3482. In addition, in practice, the pre-press portion 3482 may be achieved by a ribbed structure 3482b (shown in dashed lines in FIGS. 20, 35 and 36). The ribbed structure 3482b can be but not limited to radial. In this case, the ribbed structure 3482b pushes against the top portion 42a of the elastic restoring part 42 through the top portion of the ribbed structure 3482b. Similarly, modifying the protruding height of the ribbed structure 3482b (or the thickness of the ribbed structure 3482b) can produce an effect (e.g. modification of pressing tactile feeling) similar to that produced by modifying the depth 3482a as described above, which will not be described in addition.

In the ninth embodiment, as shown by FIG. 20, the structural plate 342 includes a plate body 3420, two side wall plates 3430 that are perpendicular to the plate body 3420 and extends in parallel, and a reinforcement rib 3432 that protrudes from the plate body 3420, which helps to increase the rigidity of the structural plate 342. Therein, the plate body 3420 is a long and narrow rectangle. The side wall plate 3430 is located at a long side edge of the plate body 3420 (e.g. the side edge 342a, corresponding to the long side edge 340a of the keycap 14). The side wall plate 3430 disposed at the long side edge of the plate body 3420 has a greater effect on increasing the rigidity of the structural plate 342 than the side wall plate 3430 disposed at the short side edge of the plate body 3420. Furthermore, the first lifting mechanism 36 and the second lifting mechanism 38 are arranged in the long side direction of the keycap 14 (i.e., in the direction parallel to the side edge 340a). The two side wall plates 3430 extend corresponding to the long side edge 340a of the keycap 34 (i.e. extending corresponding to the two long side edges of the keycap cover 346 and the two long side edges of the plate body 3420 of the structural plate 342). The two side wall plates 3430 cover the middle sections of the keycap cover 346 and the structural plate 342 with relatively weaker rigidity in the long side direction, respectively. Therefore, the rigidity of the keycap cover 346 and the structural plate 342 can be effectively enhanced, so as to reduce or eliminate the deformation of the keycap 34 caused by the linking force exerted by the first lifting mechanism 36, the second lifting mechanism 38 and the balance bracket 35, so that the first lifting mechanism 36, the second lifting mechanism 38 and the balance bracket 35 can locally and balancedly transmit the driving force through the cap 346 and the structural plate 342; thereby, the keycap cover 346 and the structural plate 342 can be kept horizontal when moving up and down. In addition, in practice, if the structural plate 342 has sufficient rigidity, the keycap cover 346 may be omitted; in this case, the appearance of the keycap can also be achieved in other ways, such as forming a coating layer on the structural plate 342.

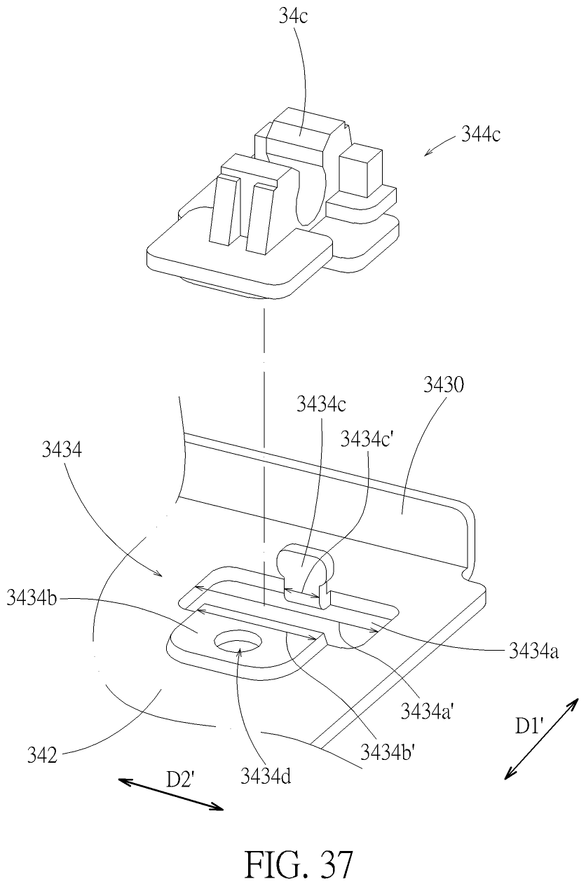

Furthermore, in the ninth embodiment, the keycap 34 also includes a reinforcement plate 341, attached to the structural plate 342, which helps to increase the rigidity of the structural plate 342. In practice, if the structural plate 342 has met the requirements, the reinforcement plate 341 can be omitted. In addition, as shown by FIG. 20 and FIG. 37, the keycap 34 includes a joining portion 344c, and the structural plate 342 includes a joining structure 3434 correspondingly. The joining portion 344c and the joining structure 3434 are firmly engaged with each other to form a balance bracket connection portion 34c. Similarly, in structural logic, the combination of the structural plate 342 and the joining portion 344c is equivalent to a keyswitch support connection structure (structurally integrated into the keycap 34, for the balance bracket 35 to be connected to keycap 34). In the ninth embodiment, the joining structure 3434 includes a joining hole 3434a, a protruding portion 3434b, and a cantilever plate 3434c. The protruding portion 3434b protrudes from a side of the structural plate (such as the upward side in FIG. 31) and forms a recess 3434d at the other side of the structural plate 342 (such as the downward side in FIG. 31). The joining hole 3434a is disposed adjacent to the protruding portion 3434b and communicates with the recess 3434d. The joining hole 3434a is located between the protruding portion 3434b and the cantilever plate 3434c. The joining portion 344c fills up the joining hole 3434a and the recess 3434d and encapsulates the protruding portion 3434b and the cantilever plate 3434c. Therein, the joining portion 344c includes first and second holding arms, which are used for forming one balance bracket connection portion 34c and are formed on the protruding portion 3434b to encapsulate the cantilever plate 3434c. Furthermore, the protruding portion 3434b, the joining hole 3434a, and the cantilever plate 3434c are arranged in the first direction D1′. The joining hole 3434a is located between the protruding portion 3434b and the cantilever plate 3434c. The width 3434a′ (or hole diameter) of the joining hole 3434a in the second direction D2′ is larger than the width 3434b′ of the protruding portion 3434b in the second direction D2′ is larger than the width 3434c′ of the cantilever plate 3434c in the second direction D2′. In structural logic, the joining structure 3434 is similar to a portion of the joining structure 3422 (i.e. the structure corresponding to the balance bracket connection portion 34c in FIG. 22 and FIG. 23). For other descriptions about the joining structure 3434 and the joining portion 344c, please refer to the relevant descriptions of the joining structure 342 and the joining portion 344a and variants thereof, which will not be repeated in addition. Furthermore, for other descriptions about the combination of the other balance bracket connection portions 34c and the structural plate 342 in the keycap 34, please refer to the relevant descriptions of the combination of the joining portions 344a and 344c and the structural plate 342 and variants thereof, which will not be repeated in addition. In addition, the combination relationship between the joining portion 344c and the structural plate 342 (through the joining structure 3434) can also be applied to the combination of the joining portion 344a (i.e. the portion thereof corresponding to the support connection portion 34a) and the joining portion 344b with the structural plate 342. For example, in structural logic, the first and second holding arms of the joining portion 344c (or with a proper modification) can be regarded as the first and second hook arms 34i and 34j of the joining portion 344b (used for forming the support connection portion 34b). In other words, the joining structure 3434 can replace the joining structure 3424, for the joining portion 344b to be joined with the structural plate 342.

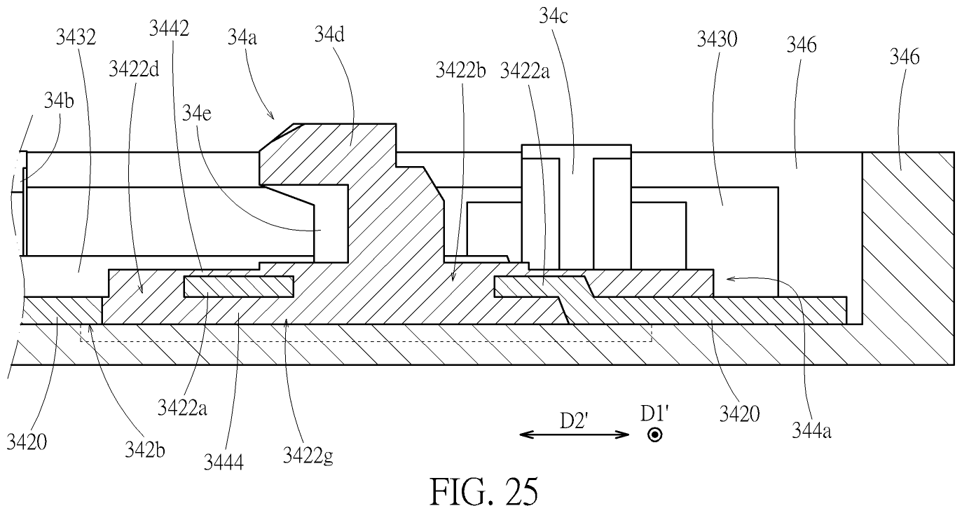

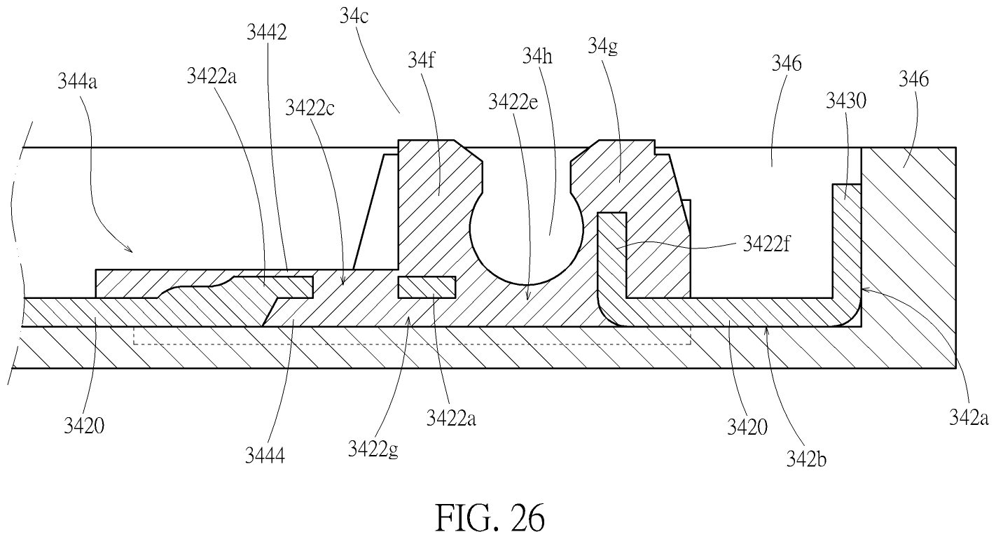

Furthermore, in the ninth embodiment, as shown by FIG. 21, the joining portions 344a, 344b and 344c are all coplanar with the top surface 342b of the structural plate 342, which can increase the bonding area between the keycap cover 346 and the structural plate 342; however, it is not limited thereto in practice. In practice, the joining portions 344a, 344b and 344c may protrude from the top surface 342b of the structural plate 342 and extend on the top surface 342b, which can increase the joining strength between the joining portions 344a, 344b and 344c and the structural plate 342 (e.g. the case in FIG. 25 and FIG. 26, in which the lower wing sheet 3444 after modified protrudes from the top surface 342b and covers a portion of the top surface 142b). In this case, the keycap cover 346 can form relief space on the bottom surface 346a corresponding to the joining portions 344a, 344b and 344c (or the portions thereof that protrude from the top surface 342b), so that the keycap cover 346 can still be effectively attached to the top surface 342b of the structural plate 342 without structural interference with the joining portions 344a, 344b and 344c. Alternatively, the relief space matches the protruding contours of the joining portions 344a, 344b and 344c, so that the inner wall surface of the relief space is also attached to the joining portions 344a, 344b and 344c.

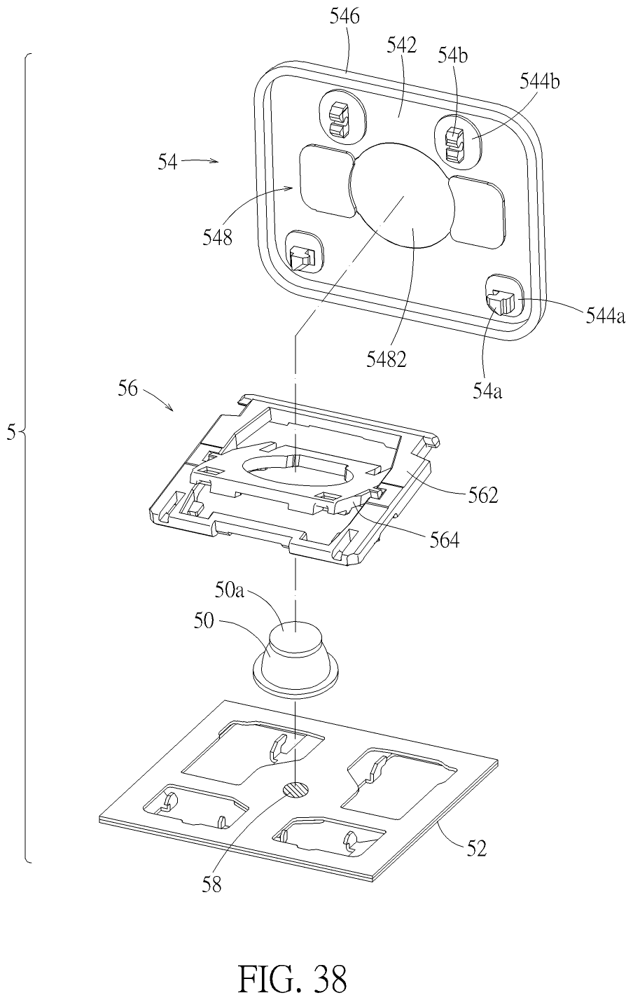

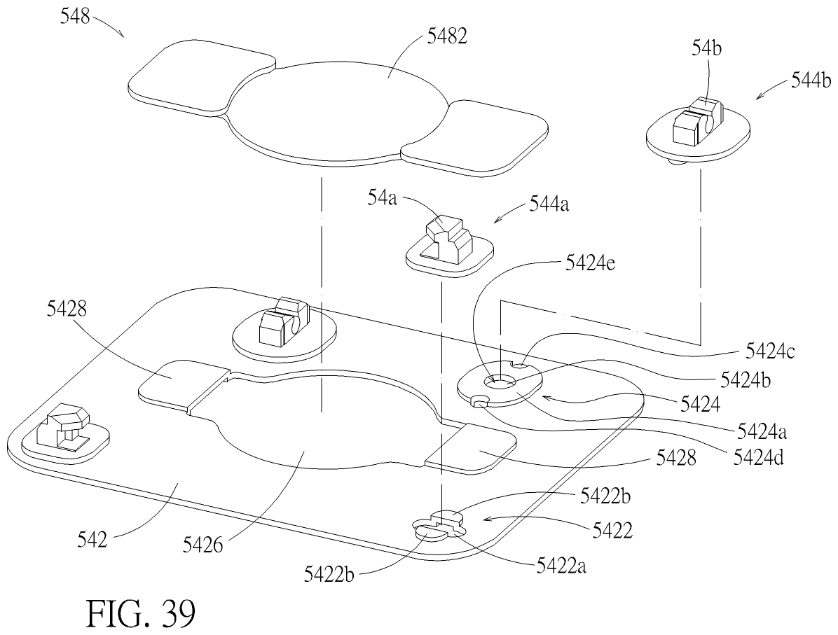

In addition, in the ninth embodiment, the first lifting mechanism 36 is achieved by a scissors-type support; however, it is not limited thereto in practice. For example, the first lifting mechanism 36 is achieved by a V-shaped butterfly support or an inverted V-shaped bat support, and the support connection portions 34a and 34b are achieved by suitable structures correspondingly, which will not be described in detail. In addition, in the ninth embodiment, the keyswitch structure 3 is a space key and the keycap 34 is supported by the two lifting mechanisms 36 and 38. It is practicable to use more lifting mechanisms to support the keycap 34 according to actual structural requirements, and the lifting mechanisms are not limited to be arranged in a single row. Furthermore, in practice, the keyswitch structure 3 can also be applied to the keyswitch structure of single-size key (or square key) , multiple-size key (or long key) or other keys with various geometric contours through proper structural modification. For example, please refer to FIG. 38 and FIG. 39. A keyswitch structure 5 according to an eleventh embodiment is a square key and includes a base 52, a keycap 54, a lifting mechanism 56, a switch 58, and an elastic restoring part 60. The keycap 54 is disposed above the base 52. The lifting mechanism 56 is connected to and between the keycap 54 and the base 52, so that the keycap 54 is vertically movable (or up and down movable) relative to the base 52 through the first lifting mechanism 56 and the second lifting mechanism 58. The switch 58 (shown by a hatched circle in the figure; for example, which is achieved by, but not limited to a membrane circuit board) is disposed under the keycap 54. The elastic restoring part 60 is disposed between the base 52 and the keycap 54 corresponding to the switch 60. The keycap 54 can be pressed down to squeeze the elastic restoring part 60 downward to trigger the switch 58. The keyswitch structure 5 and the keyswitch structure 3 are similar in structural logic. For other descriptions about the components of the keyswitch structure 5, in addition to the following descriptions, please refer to the relevant descriptions of the keyswitch structure 3 and variants thereof, which will not be repeated.

In the eleventh embodiment, the keycap 54 includes a structural plate 542, two joining portions 544a and 544b, and a keycap cover 546. The structural plate 542 has two joining structures 5422 and 5424. The joining portions 544a and 544b are firmly engaged with the joining structures 5422 and 5424 to be combined with the structural plate 542, respectively. The keycap cover 546 is fixed on the structural plate 542 for the user to touch and press. The joining portions 544a and 544b independently form the support connection portions 54a and 54b respectively. The lifting mechanism 56 includes a first keyswitch support 562 and a second keyswitch support 564, which are pivotally connected with each other and are connected to and between the keycap 54 and the base 52. Therein, the first keyswitch support 562 is connected to the support connection portion 54a of the keycap 54, and the second keyswitch support 564 is connected to the support connection portion 54b of the keycap 54. The joining structure 5422 includes a joining hole 5422a and two protruding portions 5422b disposed at two opposite sides of the joining hole 5422a. The joining portion 544a fills up the joining hole 5422a and encapsulates the two protruding portions 5422b (and fills up the recesses formed by the two protruding portions 5422b), so as to be fixed to the structural plate 542. The joining structure 5424 includes a protruding portion 5424a, a through hole 5424b, and two side holes 5424c and 5424d. The protruding portion 5424a is located at a side of the structural plate 542 (i.e. the upward side in FIG. 39) and a recess 5424e is formed at another side of the structural plate 542 (i.e. the downward side in FIG. 39). That is, in FIG. 39, the protruding portion 5424a protrudes from the structural plate 542 upward, and the opening of the recess 5424e faces below the structural plate 542. The through hole 5424b and the side holes 5424c and 5424d pass through the protruding portion 5424a. The joining portion 544b fills up the joining hole 5422a, the through hole 5424b, the side holes 5424c and 5424d, and the recess 5424e and encapsulates the protruding portion 5424a, so as to be fixed to the structural plate 542. In structural logic, the combination of the joining portion 544b and the joining structure 5424 is similar to the combination of the joining portion 344b and the joining structure 3424 in the foregoing,. Therefore, for the other descriptions about the combination of the joining portion 544b and the joining structure 5424, please refer to the relevant descriptions of the combination of the joining portion 344b and the joining structure 3424 and the variants thereof in the foregoing, which will not be repeated in addition. In practice, the combination of the joining portions 544a and 544b and the structural plate 542 can be achieved with reference to the combination of the joining portions 344a, 344b and 344c and the structural plate 342 in the keyswitch structure 3 and the variants thereof, which will not be repeated in addition. Similarly, the combination of the joining portions 544a and 544b and the structural plate 542 also can be applied to the combination of the joining portions 344a 344b and 344c and the structural plate 342, which will not be repeated. In addition, in structural logic, the combination of the structural plate 542 and the joining portion 544a is equivalent to a keyswitch support connection structure (structurally integrated into keycap 54, for the first keyswitch support 562 to be connected to keycap 54). The combination of the structural plate 542 and the joining portion 544b is equivalent to another keyswitch support connection structure (structurally integrated into keycap 54, for the second keyswitch support 564 to be connected to keycap 54).

Furthermore, in the eleventh embodiment, the first keyswitch support 562 and the second keyswitch support 564 are ring-shaped, so that the elastic restoring part 60 is disposed to pass through the first keyswitch support 562 and the second keyswitch support 564 without structural interference with the movement of the lifting mechanism 56. The keycap 54 includes a press portion 548, corresponding to an elastic restoring part 60. The structural plate 542 includes a second joining hole 5426 and two second protruding portions 5428. The two protruding portions 5428 protrude from two opposite side edges of the second joining hole 5426. The press portion 548 fills up the second joining hole 5426 and encapsulates the two second protruding portions 5428, so as to be fixed to the structural plate 542. The press portion 548 has a pre-press portion 5482, which faces the elastic restoring part 60 and can provide a preset pressure to the elastic restoring part 60 (that is, by the pre-press portion 5482 abutting against the top portion 60a of the elastic restoring part 60). When being pressed, the keycap 54 squeezes the elastic restoring part 60 through the pre-press portion 5482. For other descriptions about the press portion 548 and the second joining hole 5426, please refer to the relevant descriptions of the press portion 348 and the second joining hole 3426 and the variants thereof, which will not be repeated in addition.

As described above, in the keyswitch structures 3 and 5, the keycaps 32 and 52 and the keyswitch support connection structures structurally integrated into the keycaps 32 and 52 are combined structures. The structural plates 342 and 542 and the joining portions 344a, 344b, 344c, 544a and 544b may be made of different materials. Therefore, the keyswitch support connection structures can be easily provided with sufficient rigidity, and the structural design flexibility of the keycaps 32 and 52 and the keyswitch structures 3 and 5 can be improved, which can solve or at least improve the design limitations of the single-structure keycap in the prior art, and is conducive to the keyswitch structure thin design. The joining portions 344a, 344b, 344c, 544a and 544b and the press portions 348 and 548 are directly fixed to the structural plates 342 and 542. In the movement of the keyswitch structures 3 and 5, the structural plates 342 and 542 can directly withstand the transmission of force. This structural configuration can effectively maintain the structural stability of the keycaps 34 and 54, which can make the keyswitch structures 3 and 5 move stably. Furthermore, the portions of the keycaps 34 and 54 that touch the elastic restoring parts 42 and 60 are achieved by the press portions 348 and 548. This structural configuration helps to adjust the structural size (i.e. the structural size of the pre-press portions 3482 and 5482) in a simple manner with a lower modification cost to meet product specifications or product manufacturing requirements.

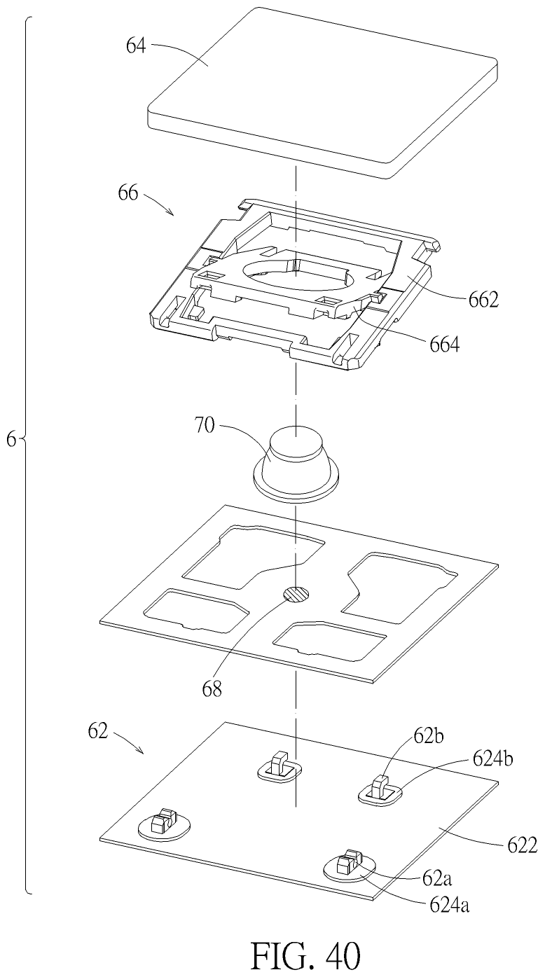

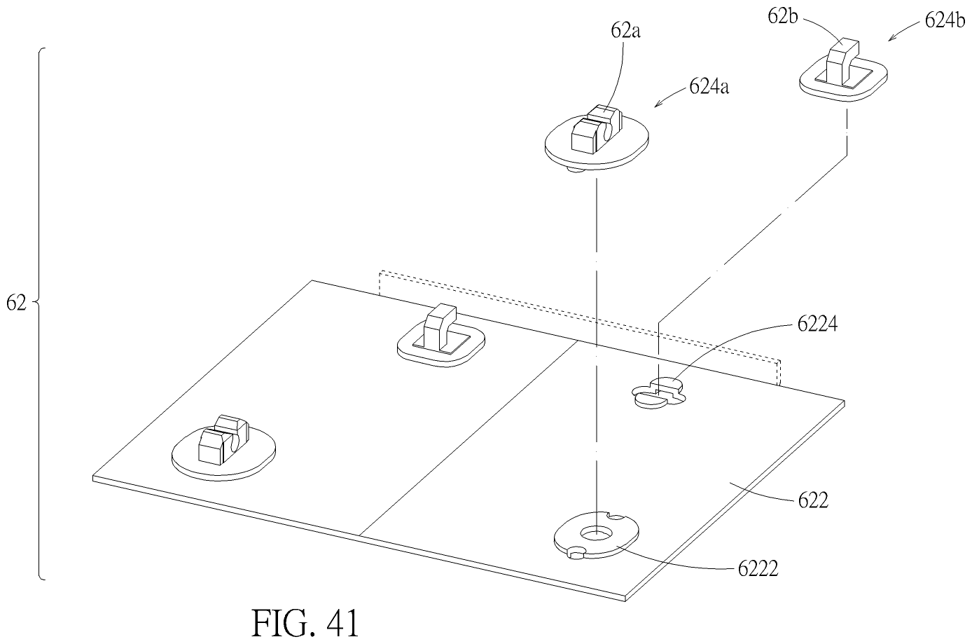

Furthermore, the above embodiments and the variants thereof are based on the fact that the keyswitch support connection structures are structurally integrated into the keycaps 32 and 52; however, it is not limited thereto in practice. For example, please refer to FIG. 40 and FIG. 41. A keyswitch structure 4 according to a twelfth embodiment includes a base 62, a keycap 64, a lifting mechanism 66, a switch 68, and an elastic restoring part 70. The keycap 64 is disposed above the base 62. The lifting mechanism 66 (including a first keyswitch support 662 and a second keyswitch support 664 which are pivotally connected with each other) is connected to and between the keycap 64 and the base 62, so that the keycap 64 is vertically movable (or up and down movable) relative to the base 62 through the lifting mechanism 66. The switch 68 (shown by a hatched circle in the figure; for example, which is achieved by, but not limited to a membrane circuit board) is disposed under the keycap 64. The elastic restoring part 70 is disposed between the base 62 and the keycap 64 corresponding to the switch 68 and located between the keycap 64 and the switch 68. The keycap 64 can be pressed down to squeeze the elastic restoring part 70 downward to trigger the switch 68. The keyswitch structure 6 and the keyswitch structure 5 are similar in structural logic. For other descriptions about the components of the keyswitch structure 6, in addition to the following descriptions, please refer to the relevant descriptions of the keyswitch structure 5 and variants thereof, which will not be repeated.

In the twelfth embodiment, the base 62 includes a structural plate 622 and two joining portions 624a and 624b. The structural plate 622 has two joining structures 6222 and 6224. The joining portions 624a and 624b are firmly engaged with the joining structures 6222 and 6224 to be combined with the structural plate 622, respectively. The joining portions 624a and 624b independently form the support connection portions 62a and 62b respectively. The first keyswitch support 662 is connected to the support connection portion 62a of the base 62, and the second keyswitch support 664 is connected to the support connection portion 62b of the base 62. Therein, the joining structures 6222 and 6224 and the joining structure 5424 of the keyswitch structure 5 are structurally similar for simplification of the description; the combination of the joining portions 624a and 624b and the joining structures 6222 and 6224 is also similar to the combination of the joining portion 544b and the joining structure 5424. Therefore, for the descriptions about the combination of the joining portions 624a and 624b and the joining structures 6222 and 6224, please refer to the relevant descriptions of the combination of the joining portion 544b and the joining structure 5424, which will not be repeated in addition. However, it is not limited thereto in practice. In addition, in practice, the structural plate 622 can be provided with a side wall plate that vertically extends from each side edge (in which the side wall plate at one of side edges is shown in dashed lines in FIG. 41), so as to increase the structural strength of the structural plate 622.

Furthermore, in structural logic, the combination of the structural plate 622 and the joining portion 624a is equivalent to a keyswitch support connection structure (structurally integrated into the base 62, for the first keyswitch support 662 to be connected to the base 62) ; the combination of the structural plate 642 and the joining portion 624b is equivalent to another keyswitch support connection structure (structurally integrated into the base 62, for the second keyswitch support 664 to be connected to the base 62). Therefore, the twelfth embodiment is based on the fact that the keyswitch support connection structures are structurally integrated into the base 62. The keyswitch support connection structures structurally integrated into the base 62 are combined structures. The structural plate 622 and the joining portions 624a and 624b may be made of different materials. Therefore, the keyswitch support connection structures can be easily provided with sufficient rigidity, and the structural design flexibility of the base 62 and the keyswitch structure 6 can be improved, which is conducive to the keyswitch structure thin design. In practice, in the keyswitch structure 6, the connecting structure of the lifting mechanism 66 and the keycap 64 can also be achieved by the connecting structure of the lifting mechanism 56 and the keycap 54 in the keyswitch structure 5 (e.g. the keyswitch support connecting structure that is structurally integrated into the keycap 52), which will not be repeated in addition. Similarly, in the keyswitch structure 6, the connecting structure of the lifting mechanism 66 and the base 62 (e.g. the keyswitch support connecting structure that is structurally integrated into the base 62) can also be applied to the connecting structure of the lifting mechanism 56 and the base 52 in the keyswitch structure 5, and the connecting structure of the lifting mechanism 36 and the base 32 in the keyswitch structure 3, which will not be repeated in addition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyswitch support connection structure, comprising:
a structural plate, comprising a protruding portion, a through hole, and at least one side hole, the protruding portion protruding from a side of the structural plate and forming a recess at another side of the structural plate, the through hole passing through a top surface of the protruding portion, the at least one side hole passing through a side wall of the protruding portion; and
a joining portion, filling up the recess, the through hole, and the at least one side hole, the joining portion comprising a first hook arm formed on the protruding portion for forming a support connection portion, a vertical projection of the first hook arm being located within the top surface of the protruding portion.

2. The keyswitch support connection structure according to claim 1, wherein the structural plate comprises a plate body and a side wall plate vertically extending from a middle section of a long side edge of the plate body.

3. The keyswitch support connection structure according to claim 1, wherein the joining portion forms a balance bracket connection portion, located between the support connection portion and a side edge of the structural plate.

4. The keyswitch support connection structure according to claim 1, wherein the at least one side hole comprises two side holes which pass through two opposite side walls of the protruding portion, and the through hole is located between the two side holes.

5. The keyswitch support connection structure according to claim 4, wherein the structural plate comprises a plate body and a side wall plate vertically extending from a middle section of a long side edge of the plate body.

6. The keyswitch support connection structure according to claim 4, wherein the joining portion forms a balance bracket connection portion, located between the support connection portion and a side edge of the structural plate.

7. A keyswitch structure comprising the keyswitch support connection structure of claim 1, wherein the keyswitch structure comprises a base, a keycap disposed above the base, a first keyswitch support connected to and between the keycap and the base, and a second keyswitch support connected to and between the keycap and the base, the keycap is vertically movable relative to the base through the first keyswitch support and the second keyswitch support, the keyswitch support connection structure is structurally integrated into the base or the keycap, and the first keyswitch support is connected to the support connection portion of the keyswitch support connection structure.

8. A keyswitch support connection structure, comprising:
a structural plate, comprising a protruding portion, a joining hole, and a cantilever plate, the protruding portion protruding from a side of the structural plate and forming a recess at another side of the structural plate, the joining hole being located between the protruding portion and the cantilever plate; and
a joining portion, filling up the joining hole and the recess, the joining portion comprising a first hook arm and a second hook arm, the first hook arm being formed on the protruding portion, the second hook arm encapsulating the cantilever plate, the first hook arm and the second hook arm being used for forming a support connection portion.

9. The keyswitch support connection structure according to claim 8, wherein the structural plate comprises a plate body and a side wall plate vertically extending from a middle section of a long side edge of the plate body.

10. The keyswitch support connection structure according to claim 8, wherein the structural plate comprises a through hole passing through a top surface of the protruding portion.

11. The keyswitch support connection structure according to claim 10, wherein the structural plate comprises a plate body and a side wall plate vertically extending from a middle section of a long side edge of the plate body.

12. The keyswitch support connection structure according to claim 8, wherein the structural plate comprises a side hole passing through a side wall of the protruding portion.

13. The keyswitch support connection structure according to claim 12, wherein the structural plate comprises a plate body and a side wall plate vertically extending from a middle section of a long side edge of the plate body.

14. The keyswitch support connection structure according to claim 8, wherein the cantilever plate bends and extends from an edge of the joining hole and has a holding structure.

15. The keyswitch support connection structure according to claim 14, wherein the structural plate comprises a plate body and a side wall plate vertically extending from a middle section of a long side edge of the plate body.

16. The keyswitch support connection structure according to claim 14, wherein the holding structure has a necking portion or a through hole.

17. The keyswitch support connection structure according to claim 8, wherein the protruding portion, the joining hole, and the cantilever plate are arranged in a first direction, a width of the joining hole in a second direction is larger than a width of the protruding portion in the second direction and is larger than a width of the cantilever plate in the second direction, and the second direction is perpendicular to the first direction.

18. The keyswitch support connection structure according to claim 17, wherein the structural plate comprises a plate body and a side wall plate vertically extending from a middle section of a long side edge of the plate body.

19. A keyswitch structure comprising the keyswitch support connection structure of claim 8, wherein the keyswitch structure comprises a base, a keycap disposed above the base, a first keyswitch support connected to and between the keycap and the base, and a second keyswitch support connected to and between the keycap and the base, the keycap is vertically movable relative to the base through the first keyswitch support and the second keyswitch support, the keyswitch support connection structure is structurally integrated into the base or the keycap, and the first keyswitch support is connected to the support connection portion of the keyswitch support connection structure.

20. A keyswitch support connection structure, comprising:
a structural plate, comprising a protruding portion, a through hole, a protruding bridge portion, and a cantilever plate, the protruding portion protruding from a side of the structural plate and forming a recess at another side of the structural plate, the through hole, the protruding bridge portion, and the cantilever plate being located on a top surface of the protruding portion, the through hole being located between the protruding bridge portion and the cantilever plate; and
a joining portion, filling up the through hole and the recess, the joining portion comprising a first hook arm and a second hook arm, the second hook arm encapsulating the protruding bridge portion, the first hook arm encapsulating the cantilever plate, the first hook arm and the second hook arm being used for forming a support connection portion.

21. The keyswitch support connection structure according to claim 20, wherein the protruding bridge portion is connected across and to two sides of the through hole, and a connection interface of the protruding bridge portion and the through hole is curved.

22. The keyswitch support connection structure according to claim 21, wherein the structural plate comprises a plate body and a side wall plate vertically extending from a middle section of a long side edge of the plate body.

23. The keyswitch support connection structure according to claim 21, wherein the joining portion forms a balance bracket connection portion, located between the support connection portion and a side edge of the structural plate.

24. The keyswitch support connection structure according to claim 20, wherein the structural plate comprises a plate body and a side wall plate vertically extending from a middle section of a long side edge of the plate body.

25. The keyswitch support connection structure according to claim 20, wherein the joining portion forms a balance bracket connection portion, located between the support connection portion and a side edge of the structural plate.

26. The keyswitch support connection structure according to claim 20, wherein the cantilever plate has a holding structure, and the holding structure has a necking portion or a through hole.

27. A keyswitch structure comprising the keyswitch support connection structure of claim 20, wherein the keyswitch structure comprises a base, a keycap disposed above the base, a first keyswitch support connected to and between the keycap and the base, and a second keyswitch support connected to and between the keycap and the base, the keycap is vertically movable relative to the base through the first keyswitch support and the second keyswitch support, the keyswitch support connection structure is structurally integrated into the base or the keycap, and the first keyswitch support is connected to the support connection portion of the keyswitch support connection structure.
